(19) United States
(12) Patent Application Publication
(10) Pub. No.: US 2024/0070665 A1
(43) Pub. Date: Feb. 29, 2024

(54) SYSTEMS AND METHODS FOR PROVIDING A STRUCTURED PRODUCT AS A DERIVATIVE-BASED INVESTMENT VEHICLE USING A DUAL POOL STRUCTURE WITH A PERIODIC RESET OPERATING ON A BLOCKCHAIN-BASED TOKEN EXCHANGE

(71) Applicant: DRXT Labs, Ltd., (US)

(72) Inventors: Lev Gelfer, Brooklyn, NY (US); Sergei Levin, Wallkill, NY (US); Greg Gurevich, Sunny Isles Beach, FL (US); Boris Shapiro, Brottby (SE); Raphaële Chappe, Brooklyn, NY (US)

(21) Appl. No.: 18/234,850

(22) Filed: Aug. 16, 2023

Related U.S. Application Data
(60) Provisional application No. 63/398,600, filed on Aug. 17, 2022.

(51) Int. Cl. G06Q 20/40; G06Q 20/38

(52) U.S. Cl. CPC G06Q 20/401; G06Q 20/389

(57) ABSTRACT

A blockchain-based exchange system includes a distributed group of computers operating a distributed consensus algorithm and having a distributed ledger. The system enables trades to be recorded on the distributed ledger. The system performs operations including receiving, from a first user, a deposit of a first value, converting the first value into a first pool token, adding the first value to a first pool, receiving, from a second user, a deposit of a second value. The system converts the second value into a second pool token, adds the second value to a second pool, performs a periodical floating payoff from the first pool to the second pool which is based on some underlying reference value (can be made to replicate an option payoff), performs a periodic fixed payoff (can be made to replicate an option premium) or floating payoff (can be made to replicate an option payoff) from the second pool to the first pool and enables traders to buy or sell first pool tokens or second pool tokens on a secondary market including a second blockchain-based exchange system.

### PRIORITY CLAIM

The present application claims priority to U.S. Provisional Application No. 63/398,600, filed on Aug. 17, 2022, the contents of which are incorporated herein by reference.

### TECHNICAL FIELD

The present technology pertains to options trading and more specifically to a new structure or framework in which two capital pools are established that exchange cash flows between each other periodically and wherein token representing value in one of the two pools can be traded on a blockchain-based exchange or secondary market.

### BACKGROUND

Traditional financial markets offer popular products and services that provide customized exposure to otherwise hard-to-reach asset classes, without the need to trade options and engage in delta-hedging. Structured products are derivative-based investment vehicles that provide a return based on the performance of an underlying asset. The asset can cover the equity, index, fund, interest rate, currency, commodity or property markets. The payoff of structured products can be arbitrarily complex. For example, the level of capital at risk can be pre-defined or the investor can be completely protected from losing their principal amount. Payoff profiles can be designed to take advantage of rising, falling or range bound markets, and delivered in a way that can be tailored to the needs of investors. In essence, structured products allow investors to profit from scenarios that are different from the asset simply going up or down.

Structured products are very popular in traditional financial markets, but their adoption in the cryptocurrency space has been slow. What is currently called structured products in the cryptocurrency space can be broadly broken into two classes, perpetual swaps and option vaults. Perpetual swaps are structured vehicles designed to circumvent the lack of natural funding in cryptocurrency to provide leverage to the investors. Unfortunately, these products suffer from serious drawbacks that arise from their self-referential nature. If cash flows being paid depend on the price of the product itself, there is a lot of potential for manipulation. Option vaults are deposits that offer rudimentary volatility strategies such as call overwriting and cash-secured put selling. While efforts have been made to create more flexible structured derivatives on the blockchain, so far none of these projects have succeeded.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example long volatility quantitative strategy in accordance with various aspects of this disclosure;

FIG. 2 illustrates a short volatility quantitative strategy in accordance with various aspects of

this disclosure;

FIG. 3 illustrates a dual pool structure framework in accordance with various aspects of this disclosure;

FIG. 4 illustrates an example timeline in accordance with various aspects of this disclosure;

FIG. 5 illustrates a straddle (“harvesting”) strategy in accordance with various aspects of this disclosure;

FIG. 6 illustrates a straddle strategy (where the investor chooses to be short-volatility, such that the issuer is long-volatility) in accordance with various aspects of this disclosure;

FIG. 7 illustrates different possible payoffs for a strategy of providing yields when an underlying asset is expected to be range-bound during a period of time in accordance with various aspects of this disclosure;

FIG. 8 illustrates different possible payoffs for a strategy of providing yields that is based on the performance of three underlying assets (the minimum return of three separate underlying assets) during a period of time in accordance with various aspects of this disclosure;

FIG. 9 illustrates a payoff percentage graph for those who want to hedge impermanent loss associated with providing liquidity on a decentralized exchange such as Uniswap (i.e. through a constant-product Automated Market Maker) in accordance with various aspects of this disclosure;

FIG. 10 illustrates an approach to downside protection on a cryptocurrency inventory in accordance with various aspects of this disclosure;

FIG. 11 illustrates different possible payoffs for a principal protection strategy according to some aspects of this disclosure;

FIG. 12A illustrates the mechanisms of a principal protection strategy in accordance with various aspects of this disclosure;

FIG. 12B illustrates the mechanisms of a principal protection strategy in accordance with various aspects of this disclosure;

FIG. 12C illustrates the mechanisms of a principal protection strategy in accordance with various aspects of this disclosure;

FIG. 13A illustrates an example method in accordance with various aspects of this disclosure;

FIG. 13B illustrates an example method in accordance with various aspects of this disclosure;

FIG. 14A illustrates another method of providing a dual-pool structure according to some aspects of this disclosure;

FIG. 14B illustrates another method for operating a platform, according to some aspects of this disclosure;

FIG. 15 illustrates an example system according to an aspect of this disclosure; and

FIG. 16 illustrates an example blockchain network in according to some aspects of this disclosure.

### DESCRIPTION OF EXAMPLE EMBODIMENTS

Various embodiments of the disclosure are discussed in detail below. While specific implementations are discussed, it should be understood that this is done for illustration purposes. A person skilled in the relevant art will recognize that other components and configurations may be used without parting from the spirit and scope of the disclosure.

### Overview

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed herein are systems, methods, and computer-readable media for providing a solution for a decentralized-finance (DeFi) specific framework. DeFi derivatives are financial contracts which track or provide exposure to an underlying asset. The most common derivatives products in cryptocurrency markets are futures and options. In cryptocurrency markets, derivatives are traded at greater volumes than the underlying spot markets. This means there is more buying and selling of Bitcoin futures than there is of actual Bitcoin.

The approach disclosed herein is an institutional grade platform for issuing on-chain (i.e., on a blockchain) structured products, with benefits for both issuers and investors. The benefits for issuers can include the ability to customize any structured payoff of arbitrary complexity. Payoffs can be linked to any cryptocurrency token and denominated in any base currency. For example, the base current could be Bitcoin or Ethereum or other cryptocurrency. In some aspects, there are two pools disclosed herein will use the same type of base currency token. The benefits for investors can include access to structured payoffs without directly holding spot assets or actively trading. The platform includes transparent on-chain pricing, execution, and settlement. In one aspect there is no counterparty risk due to fully collateralized payoffs. Thus, the physical structure of using two different pools as disclosed herein and utilizing the nature of blockchain networks addresses technical issues in the prior art.

The technology can be used for business-to-business context and can provide a scalable platform for issuing on-chain structured products as well as complementary services. Issuers can be responsible for customer acquisition, marketing & distribution, legal & regulatory compliance, and hedging. There are structured product parameters associated with the platform. Each structured product on the platform can be designed as a swap between two pools of capital (no expiration date), while more complex products can also include additional steps (for example, a principal protection strategy can involve the purchase of Treasury-backed tokens from a third party). Periodically, the two pools settle the trade by exchanging payments. Payoffs can be linked to any price source and denominated in any base currency. Periodic (such as every one hour or some other time frame) redemption and deposit period can be applied for each product as well as secondary liquidity using ERC-20 tokens or any other kind of token. ERC-20 tokens relate to or stand for “Ethereum Request for Comment 20’. It is a technical standard used for smart contracts on the Ethereum blockchain

In some aspects, the techniques described herein relate to a structured investment system including: a processor; and a computer-readable storage device storing instructions which, when executed by the processor, cause the processor to perform operations including: receiving, from a first user device, a deposit of a first value denominated in a base currency token to yield a first amount of deposited base currency token; adding the first amount of deposited base currency token to a first pool; converting the first amount of deposited base currency token into a first pool token received by the first user device in exchange for the first amount of deposited base currency token; receiving, from a second user device, a deposit of a second value denominated in the base currency token to yield a second amount of deposited base currency token; adding the second amount of deposited base currency token to a second pool; converting the second amount of deposited base currency token into a second pool token received by the second user device in exchange for the second amount of deposited base currency token; performing a first periodic payment denominated in base currency token from the first pool to the second pool; and performing a second periodic payment denominated in the base currency token from the second pool to the first pool, wherein the first periodic payment and the second periodic payment are both denominated in the base currency token and are recorded on a blockchain-based network including a distributed group of computers operating a distributed consensus algorithm that causes, upon a consensus being reached by the distributed consensus algorithm for a confirmed transaction, data associated with the confirmed transaction to be transformed from a changeable state in a computer memory to an immutable state recorded on a distributed ledger associated with a plurality of distributed computer memories across the distributed group of computers, and wherein the first user device can buy or sell first pool tokens on a blockchain-based exchange and wherein the second user device can buy or sell second pool tokens on the blockchain-based exchange.

In some aspects, the techniques described herein relate to a method of operating an investment system, the method including: receiving, from a first user device, a deposit of a first value denominated in a base currency token to yield a first deposited amount of base currency token; adding the first deposited amount of base currency token to a first pool; converting the first deposited amount of base currency token into a first pool token received by the first user device in exchange for the first deposited amount of base currency token; receiving, from a second user device, a deposit of a second value denominated in the base currency token to yield a second deposited amount of base currency token; adding the second deposited amount of base currency token to a second pool; converting the second deposited amount of base currency token into a second pool token received by the second user device in exchange for the second deposited amount of base currency token; performing a first periodic payment denominated in base currency token from the first pool to the second pool; and performing a second periodic payment denominated in base currency token from the second pool to the first pool, wherein the first periodic payment and the second periodic payment are recorded on a blockchain-based network including a distributed group of computers operating a distributed consensus algorithm that causes, upon a consensus being reached by the distributed consensus algorithm for a confirmed transaction, data associated with the confirmed transaction to be transformed from a changeable state in a computer memory to an immutable state recorded on a distributed ledger associated with a plurality of distributed computer memories across the distributed group of computers, and wherein the first user device can buy or sell first pool tokens on a blockchain-based exchange and wherein the second user device can buy or sell second pool tokens on the blockchain-based exchange.

In some aspects, the techniques described herein relate to a structured investment system including: a blockchain-based exchange system including a distributed group of computers operating a distributed consensus algorithm that causes confirmed transactions to be recorded on a distributed ledger across the distributed group of computers; at least one processor; and a computer-readable storage device storing instructions which, when executed by the at least one processor, cause the at least one processor to perform operations including: receiving, from a first user device, a deposit of a first value denominated in base currency tokens to yield a first amount of base currency tokens; converting the first amount of base currency tokens into a first pool token; adding the first deposit of base currency tokens to a first pool; receiving, from a second user device, a deposit of a second value denominated in base currency tokens to yield a second amount of base currency tokens; converting the second amount of base currency tokens into a second pool token; adding the second amount of base currency tokens to a second pool; performing a first periodic payment from the first pool to the second pool; and performing a second periodic payment from the second pool to the first pool, wherein deposits of the first value and the second value can only happen at a specific deposit and redemption window, wherein the first value in the first pool and the second value in the second pool is evidenced by the first pool token and the second pool token which can be redeemed from the first pool and second pool in exchange for base currency tokens during the specific deposit and redemption window, wherein outside of the deposit and redemption window, traders can buy or sell first pool tokens or second pool tokens in which, upon a consensus being reached by a distributed consensus algorithm operating on a blockchain network across a distributed group of computers for a confirmed transaction, data associated with the confirmed transaction is transformed from a changeable state in a computer memory to an immutable state recorded on a distributed ledger associated with a plurality of distributed computer memories across the distributed group of computers.

In some aspects, the techniques described herein relate to a method including: receiving, from a first user device, a deposit of a first value; converting, via a smart contract operating on a blockchain network, the first value into a first pool token, wherein the blockchain network includes a distributed group of computers operating a distributed consensus algorithm, wherein upon a consensus being reached by the distributed consensus algorithm for a confirmed transaction, data associated with the confirmed transaction is transformed from a changeable state in a computer memory to an immutable state recorded on a distributed ledger associated with a plurality of distributed computer memories across the distributed group of computers; adding, via the smart contract operating on the blockchain network, the first value to a first pool in exchange for a first pool token; receiving, from a second user device and via the smart contract operating on the blockchain network, a deposit of a second value in a second pool in exchange for a second pool token; performing a periodic option payoff from the first pool to the second pool such that confirmed transactions are recorded on the distributed ledger of the blockchain network; performing a periodic premium or option payment from the second pool to the first pool such that confirmed transactions are recorded on the distributed ledger of the blockchain network; enabling traders to deposit in or redeem value from either pool at specific time windows such that confirmed transactions are recorded on the distributed ledger of the blockchain network; and enabling traders to buy or sell first pool tokens or second pool tokens on a centralized or decentralized blockchain-based exchange.

In some aspects, the techniques described herein relate to a system including: a processor; and a computer-readable storage device storing instructions which, when executed by the processor, cause the processor to perform operations including: receiving, from a first user device, a deposit of a first value denominated in a base currency token to yield a first amount of deposited base currency token; converting, via a smart contract operating on a first blockchain network, the first value into a first pool token, wherein the first blockchain network includes a distributed group of computers operating a distributed consensus algorithm, wherein upon a consensus being reached by the distributed consensus algorithm for a confirmed transaction, data associated with the confirmed transaction is transformed from a changeable state in a computer memory to an immutable state recorded on a distributed ledger associated with a plurality of distributed computer memories across the distributed group of computers; adding the first amount of deposited base currency token to a first pool; receiving, from a second user device, a deposit of a second value denominated in the base currency token to yield a second amount of deposited base currency token; converting, via the smart contract operating on a blockchain network, the second value into a second pool token; adding the second amount of deposited base currency token to a second pool; performing a periodical option payoff from the first pool to the second pool; performing a periodic premium payment from the second pool to the first pool; and enabling traders to buy or sell first pool tokens or second pool tokens such that confirmed transactions are recorded on a second blockchain network having a second distributed ledger.

In some aspects, the techniques described herein relate to a method of operating a structured trading platform, the method including: receiving in a quantitative pool, funding tokens from a user; at an end of a periodic period of time, via a platform, implementing a predefined option trading strategy associated with one of a long volatility trading strategy or a short volatility trading strategy; and buying or selling, via the platform, volatility exposure using tokens in the quantitative pool according to the predefined option trading strategy, such that confirmed transactions are recorded on a blockchain network that includes a distributed group of computers operating a distributed consensus algorithm, wherein upon a consensus being reached by the distributed consensus algorithm for a confirmed transaction of the confirmed transactions, data associated with the confirmed transaction is transformed from a changeable state in a computer memory to an immutable state recorded on a distributed ledger associated with a plurality of distributed computer memories across the distributed group of computers.

In some aspects, the techniques described herein relate to a system including: a processor; and a computer-readable storage device storing instructions which, when executed by the processor, cause the processor to perform operations including: receiving in a quantitative pool, base currency tokens (“funding tokens”) from a user; at an end of a periodic period of time, via a platform, implementing a predefined option trading strategy associated with one of a long volatility trading strategy or a short volatility trading strategy; and buying or selling, via the platform, volatility exposure using tokens in the quantitative pool according to the predefined option trading strategy, such that confirmed transactions are recoded on a blockchain network that includes a distributed group of computers operating a distributed consensus algorithm, wherein upon a consensus being reached by the distributed consensus algorithm for a confirmed transaction of the confirmed transactions, data associated with the confirmed transaction is transformed from a changeable state in a computer memory to an immutable state recorded on a distributed ledger associated with a plurality of distributed computer memories across the distributed group of computers.

The various aspects can be claimed from the standpoint of a platform, a computing device, a blockchain network, or a combination of these components. Some aspects can include a system including one or more means of performing any function or operations disclosed herein. Some aspects can include a non-transitory computer-readable device that stores instructions which, when executed by a processor, cause the processor to perform one or more operations disclosed herein.

There are processes and timelines in connection with the structure including the connection to a secondary market which is a blockchain-based exchange for trading tokens. The details of these processes are described in more detail in the Appendices below.

This brief introduction is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and embodiments, will become more apparent upon referring to the following specification, claims, and accompanying drawings.

### DETAILED DESCRIPTION

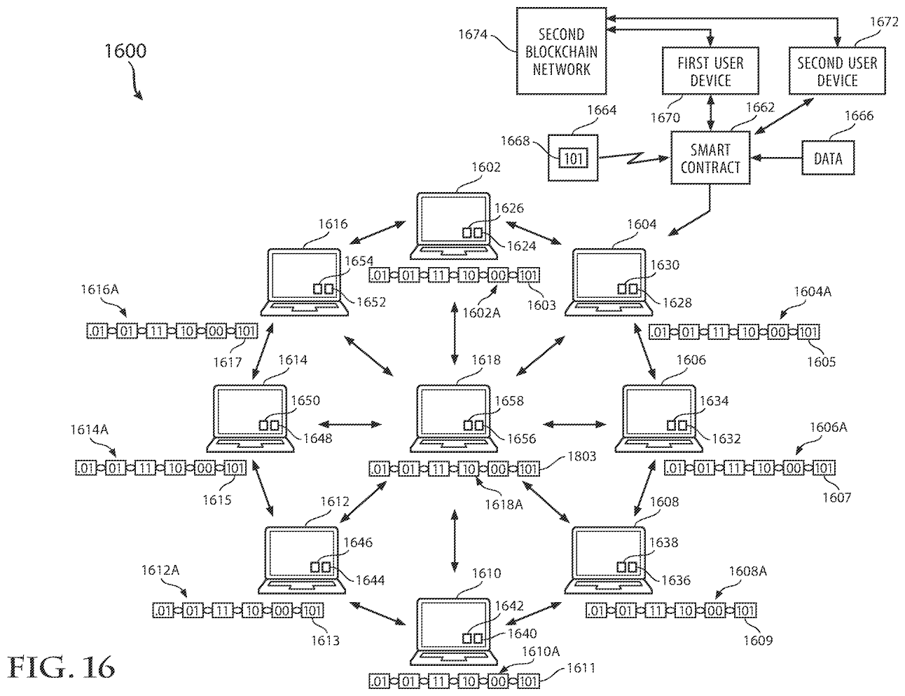

The disclosed technology involves systems, methods, and computer-readable media for providing a new options cryptocurrency trading platform. Instead of trying to replicate products from traditional finance, this disclosure introduces new quantitative strategies for a decentralized-finance (DeFi)-specific framework that allows users to profit from the realized volatility of cryptocurrency without trading options. The platform operates on a blockchain network that causes data related to trading transactions and stored in a computer memory to transition from being changeable to being immutable when confirmed by a consensus algorithm distributed across a plurality of distributed computing devices or nodes. The data is recorded in a plurality of different computer memory devices associated with the plurality of distributed computing devices and on a distributed ledger. FIG. 16 provides more details about the blockchain network disclosed herein.

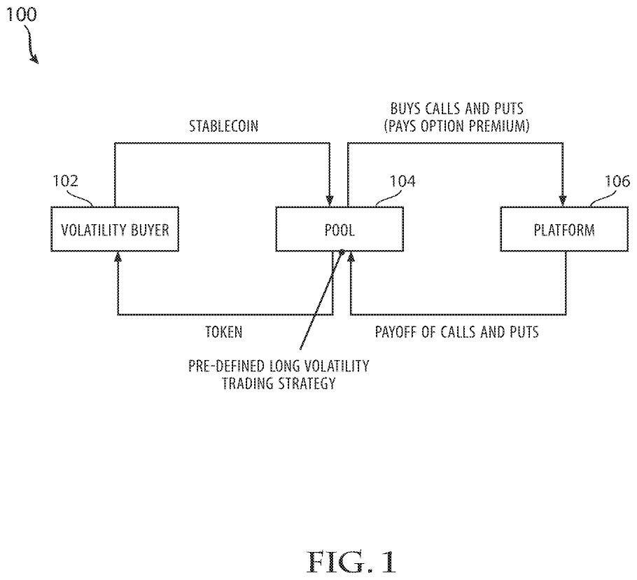

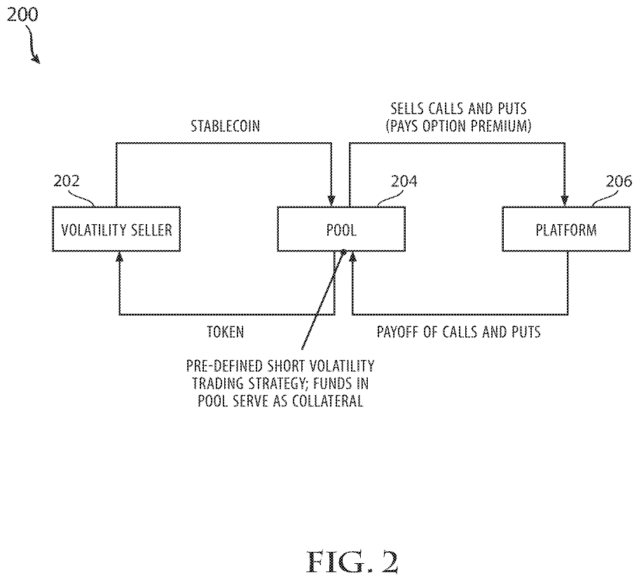

FIG. 1 illustrates an example long volatility quantitative strategy 100 in accordance with various aspects of this disclosure. FIG. 2 illustrates a short volatility quantitative strategy 200 in accordance with various aspects of this disclosure.

The disclosed quantitative strategy can be conceived as buying or selling some kind of volatility exposure to an underlying with a periodic frequency (currently envisioned as daily, bi-daily or weekly, but also non-periodic as mentioned above), based on a pre-existing trading strategy (e.g. buy or sell a call daily, for a specific underlying asset, with a specific maturity). FIG. 1 illustrates a single capital pool 104 that buys or sells calls and puts periodically with a specific pre-defined option trading strategy which could be, for example, buying calls and puts as shown in FIG. 1 or selling calls and puts as shown in FIG. 2, all on the platform and powered by the disclosed protocol. Users such as volatility buyer 102 deposit (or withdraw) funds into pools 104 by buying or selling back pool tokens, with fixed deposit/withdrawal windows. The platform 106 can be used by the pool 104 to buy calls and puts and to provides payoffs of calls and puts to the quantitative pool 104. The pool 104 can include a pre-defined long volatility trading strategy. Pool tokens can be ERC-20 or Ethereum based tokens or any other cryptocurrency or blockchain-based token. In one example, transactions managed by the platform 106 can be recorded and/or managed on a blockchain network (not shown) can be built on Polygon, which is a blockchain platform that aims to create a multi-chain blockchain system compatible with Ethereum.

To the extent that the pool 104 is selling calls and puts, the disclosed protocol accesses funds in the pool balance to provide full collateral, i.e. is able to block part of them in order to cover the nominal value of a short sale. Other more complex multi-leg strategies involving any combination of calls and puts (long or short) can also be implemented. The pre-defined trading strategy can be designed with a lot of flexibility to suit client needs, including more exotic payoffs.

FIG. 2 shows the short volatility quantitative strategy 200 with a volatility seller 202, a quantitative pool 204 and a platform 206 in which the pool 204 has a pre-defined short volatility trading strategy. Funds in the pool 204 in this case server as collateral.

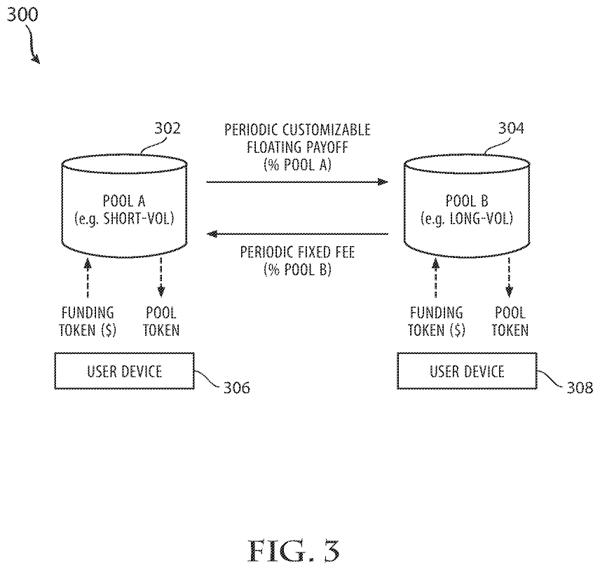

FIG. 3 illustrates a dual pool structure framework 300 in accordance with various aspects of this disclosure. The structured product consists of two capital pools 302, 304 as shown in FIG. 3. Pool A 302 and Pool B 304 can exchange cash flows between each other periodically or on some other time frame that may not be periodic. In some strategies, the platform only looks at the value of the underlying asset at the end of the period. In other strategies, the platform looks at what happened during the entirely of the period (e.g. if it touched a barrier value at any time during the period, the payment will immediately be 0 at the end of the period). Pool A 302 may provide a short volatility strategy and receive funding tokens and provide pool tokens. Pool B 304 may provide a long volatility strategy and receive funding tokens and provide a pool token. Pool tokens can be ERC-20 or Ethereum based tokens or any other cryptocurrency or blockchain-based token. User devices 306, 308 can represent user computing devices that provide a user interface and that enable the users or traders to provide funding tokens and receive pool tokens and to participate in the pools 302/304. The user devices 306, 308 can have an application, wallet or other computer program code to enable interaction with the pools 302/304 in order to participate. In some aspects, the periodic exchange can be daily, bi-daily or weekly. In other aspects, the exchange timing may not be periodic but based on some trigger value which may not be daily or weekly. The timing may also be random. In some aspect, the exchange between the pools happens at specific times that are pre-determined, not randomly. It is possible that the value of the underlying reference asset is measured over a specific time period (e.g. if the underlying exceeds some value at any point during the observation period, then a certain event or events happen). It is also possible that the value of the underlying reference asset be assessed at one specific point in time (e.g. if the value of the underlying at the end of the observation window is a, the return over the period is b, then x y z happens).

The timing of the periodic exchange can be daily, bi-daily or weekly or any other time window, less a small window for deposit/withdrawal pool balance readjustment. The timing and/or the small window is fully customizable. Each pool pays a percentage of its balance. This percentage can be fixed in advance, or floating, that is dependent on one or more underlying reference value(s). Reference value(s) can be observed at the beginning and at the end of the period, or can be observed periodically during the observation period. For example, pool A 302 may provide a periodic customizable floating payoff (a percent of the pool A) to pool B 304. The pool B 304 may provide a periodic customizable fixed payoff (a fixed percent of pool B) or floating payoff (a floating percentage of pool B) 304 as a payment to pool A 302. A pool is a collection of cryptocurrencies or tokens locked in a smart contract. Users deposit (or withdraw) funds (funding tokens) (via user devices 306, 308) into pools by buying or selling back pool tokens, within fixed deposit/withdrawal windows.

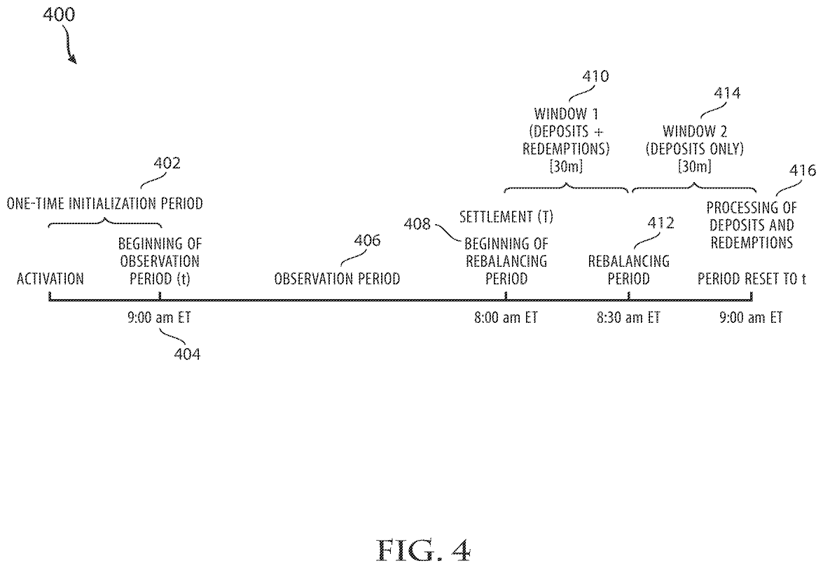

At the beginning of a period of time (e.g., such as at a particular time associated with a deposit/withdrawal window), each pool 302, 304 starts with a specific balance. At the end of a period of time (e.g., an observation period as shown in FIG. 4), the pools 302, 304 exchange cash flows. Cash flows are proportional in nature, i.e. defined as a fraction of the total value of the pool as shown in FIG. 3. For example, pool A 302 pays pool B 304 a cash flow linked to a value of the underlying reference value, which mathematically can be defined by a payoff function multiplied by the pool starting balance. Pool B 304 can pay pool A 302 a fixed percentage (x %) of its starting balance. Additionally, both pools 302, 304 can be charged a fee 106/206, as a percentage of each pool starting balance.

In practice, one of the pools 302, 304 may offer a specific volatility exposure or payoff that might be attractive for investors (for example, shorting volatility). To be able to meet investor demand, the other pool could be used by a manager to take the opposite exposure (and hedge separately). Note that any manager investing in a pool would be able to manage risk separately, including by buying or selling pool tokens on any centralized or decentralized exchange since pool tokens can be ERC-20. Transactions are recorded on blockchain networks as described herein.

FIG. 4 illustrates an example timeline 400 in accordance with various aspects of this disclosure. The following describes an activation and initialization period 402. At some point after the beginning of an observation period 404 and during an initialization period 406, the issuer sends de minimis amounts of funding tokens in exchange for pool tokens (for both pools 302, 304), but in the right ratios. This only happens once, when the structure is first activated. Next is described an observation period 406. At the beginning of each period (t) 404, pool A 302 and pool B 304 start with specific balances Aₜ and Bₜ. The price of the underlying asset is Pₜ. The observation period 406 can have a duration [t, T] which is flexible (can be a daily, bi-daily or weekly interval or some other type of interval) during which the value of the underlying asset will fluctuate. At the end of the observation period 404 and at settlement or the beginning of the rebalancing period 408, the value of the underlier P_{T} is observed. Any underlier can be used as long as there is a value that an oracle or other mechanism can make available on-chain.

Next is a settlement period (T) starting with a window 1 410. At the end of the observation period 406, the smart contract calculates the cash-flows between the two pools on the basis of the reference value P_{T}. The floating leg (pool A to pool B) is f(Pₜ, P_{T})×Aₜ where f(Pₜ, P_{T}) is the payoff function with arguments Pₜ and P_{T} and range [0,1] (the fraction of pool A balance that is paid cannot exceed 100%). The fixed leg (pool B to pool A) is α×Bₜ (with 0<α<1).

Pool balances are adjusted to reflect the cash flows being exchanged between the pools 302, 304 (settlement) as follows:

A_{T}=Aₜ+α×Bₜ−f(Pₜ, P_{T})×Aₜ−μ×Aₜ

B_{T}=Bₜ−α×Bₜ+f(Pₜ, P_{T})×Aₜ−μ×Bₜ

Where μ is a small fee charged as a percentage of each pool's starting balance. The rebalancing period 412 is described next. After settlement, there is a rebalancing period (e.g., one hour in total or some other time frame) during which investors can readjust balances in the pools. This rebalancing period 412 can be broken down into two windows (each with a fixed or dynamic time, such as 30 minutes). A first window 410 is shown during which participants are allowed to submit both deposits and redemption requests to and from the two capital pools 302, 304. In the first window 410, all submitted requests are processed at the end of the rebalancing period 412. A second window 414 is shown during which only deposit requests can be placed. The second window can have a time frame such as 30 minutes. For example, redemption requests may be disallowed to prevent spoofing. All submitted deposit and redemptions requests are processed at the end of the rebalancing period 416.

Next is discussed the processing of deposit and redemption requests. At the end of the rebalancing period 412, all pending redemption and deposit requests are processed 416 based on pool token prices as calculated by a smart contract. Smart contracts are programs stored on a blockchain (e.g., one or more nodes on a blockchain 1800 shown in FIG. 16) that run when predetermined conditions are met. Smart contracts are typically used to automate the execution of an agreement or instructions so that all participants can be immediately certain of the outcome, without any intermediary's involvement or time loss. Smart contracts can be code written into a blockchain that executes the terms of an agreement or contract from outside the blockchain. The smart contract automates the actions that would otherwise be completed by the parties in the agreement, which removes the need for both parties to trust each other. The two capital pools may be smart contracts on the blockchain shown in FIG. 16, in one example.

The price for each pool token (p_{A} and p_{B}) is based on pool balances after settlement:

$${p}_{A} = \frac{{A}_{T}}{{n}_{A}}$$

$$and$$

$${p}_{B} = \frac{{B}_{T}}{{n}_{B}} ,$$

where n_{A} and n_{B} are the number of pool tokens for pool A 302 and pool B 304. For deposit requests, funding tokens are debited from user accounts. Users receive pool tokens (as shown in FIG. 3) in an amount equal to the number of funding tokens debited divided by the pool token price. For redemption requests, pool tokens are debited from user accounts and burned. Burning a token from the blockchain means permanently removing the token or tokens from circulation. Typically, the burning process can be done by transferring tokens in question to a burn address or a wallet from which they can ever be retrieved. Users get funding tokens in an amount equal to the number of pool tokens burned, multiplied by the pool token price. In one aspect, pool tokens can also be traded (bought or sold) on a blockchain-based exchange which can be different from the blockchain operating the two capital pools.

If all the funding tokens are removed from either of the two pools 302/304, the smart contract shuts down automatically, invoking an automatic withdrawal of all funds from the other side. Shutting down the smart contract is done to prevent manipulation by depositors in either of the two pools 302, 304, to have a fail-safe in case of inability of depositors to one side to continue business as usual. Shutting down the smart contract in this scenario is also a normal way to terminate a contract by one of the sides.

Pool balances are adjusted for funding tokens deposited and withdrawn:

A_{T}=A_{T}+Deposits−Redemptions

B_{T}=B_{T}+Deposits−Redemptions

A period reset which can occur at the end of the second window 414 or around the time of processing the deposits and redemptions 416 is described next. Pool end balances become starting balances for the next cycle.

Aₜ=A_{T}

Bₜ=B_{T}

A payoff function f can be different for different strategies. The following is a description of various payoff strategies which can be implemented. These and other strategies can be deployed.

In some aspects, a call payoff strategy can be implemented. To replicate the payoff of a call, the smart contract uses

$$f = Min ( Max ( \frac{{P}_{T} - K}{{P}_{t}} , 0 ) 1 ) ,$$

where K is the strike of the call option. A put payoff is next described. To replicate the payoff of a put, the smart contract uses

$$f = Min ( Max ( \frac{K - {P}_{T}}{{P}_{t}} , 0 ) 1 ) ,$$

where K is the strike of the put option.

A straddle payoff strategy can be implemented. To replicate the payoff of a straddle, the smart contract uses

$$f = Min ( \vert \frac{{P}_{T} - K}{{P}_{t}} - 1 \vert , 1 ) ,$$

where | . . . | is the absolute value.

A butterfly payoff strategy can be implemented. To replicate the payoff of a butterfly, the

smart contract uses:

$$f = Min ( \vert \frac{{P}_{T}}{{P}_{t}} - 1 \vert - Max ( 0 , \vert \frac{{P}_{T}}{{P}_{t}} - 1 \vert - β ) , 1 ) ,$$

where | . . . | is the absolute value and β is the maximum payoff of the butterfly.

A barrier option payoff strategy can be implemented. To replicate the payoff of a barrier option, the smart contract uses: f=0 if the value of the underlier (observed with periodic frequency during the observation period [t, T]) stays within of a pre-defined interval [a, b]; and f=β if the value of the underlier asset ever falls outside of [a, b], where a and b are some lower-bound and upper-bound values respectively, and β is a pre-defined percentage with 0<β<1.

Instead of replicating traditional option strategies, other payoff functions could be tailored to more DeFi specific needs, for instance:

A Uniswap V2 hedge payoff strategy can be implemented. Another name for the hedge payoff is impermanent loss hedge. To provide positive convexity to offset the negative convexity of providing liquidity on Uniswap V2, the system uses:

$$f = 0.5 \times ( \frac{{P}_{T}}{{P}_{t}} + 1 ) - \sqrt{\frac{{P}_{T}}{{P}_{t}}} .$$

A miner production hedge strategy can be implemented. To provide downside protection to miners on the cryptocurrency inventory that they hold, the smart contract uses a more complex function that combines two strategies, a long a put option that expires at T and a simultaneous series of periodic out-of-the-money (OTM) short calls during the observation period [t, T]: the payoff of a long put options

$$f = Min ( Max ( \frac{K - {P}_{T}}{{P}_{t}} , 0 ) , 1 ) ,$$

where K is the strike of the put option and equal to 90% of the spot price at t,

$$less = {\sum }_{i = 1}^{i = T - 1} Min ( Max ( \frac{{P}_{i + 1} - K}{{P}_{i}} , 0 ) , 1 )$$

where K is the strike of the call options equal to 90% of the spot price at t=i and the value of the underlier is observed with daily periodic frequency t=1, . . . , T during the observation period [t,T].

Pricing is discussed next. Every deposit into a quantitative strategy pool can generate a pool token (essentially a deposit certificate) which has to be returned to get back the deposit adjusted for profit/loss. When the money is deposited, from the user's perspective, the process looks (in fact) like the user is buying n (e.g., where n is a number) pool tokens for price p where p×n is the total deposit. To withdraw, the user would essentially sell these tokens back to the pool 302/304 for p adjusted for profit/loss of the pool. Meanwhile, the tokens would reside in the user's wallet and behave the same as any other ERC-20 token. The existence of these pool tokens will add two important features to the disclosed ecosystem, secondary liquidity and risk transfer, which may be essential to any structured product manager investing in a pool to provide liquidity for the other pool. FIG. 16 shows two blockchain networks. One represents the secondary liquidity opportunity where traders or product managers could sell their pool tokens if desired on a different blockchain-based exchange.

The ratio of funds in the pools naturally defines the market cost of the quantitative strategy payoff, thus creating an auction market at the time of reset. In essence, pool B 304 is buying the payoff from pool A 302 for a fee. Per unit of underlying, in each period the price of the payoff is:

$$Price = a \times \frac{{B}_{t}}{{A}_{t}}$$

The deposits and withdrawals on both sides from arbitrageurs can take advantage of the mispricing of volatility as compared to options markets. Given an efficient market where multiple managers compete with each other, periodically re-adjusting their balances in each pool, prices of volatility on strategies will converge to be consistent with prices of volatility on options markets.

Harvesting the volatility risk premium (VRP) is a common long-term strategy for investors in most asset classes because market participants are willing to overpay for protection. The volatility risk premium refers to the fact that on average, over time implied volatility tends to be higher than realized volatility. VRP harvesting is a mature approach to generating income on client holdings, which has been around for decades in traditional financial markets and does not depend on inefficiency of the market but rather is a form of insurance staking. Traditional financial markets have popular products for VRP harvesting like variance swaps that do not require trading options and delta-hedging. No such DeFi products exist yet in the cryptocurrency space even though implied volatility is rich and ripe for VRP harvesting. Instead of trying to replicate products from traditional finance, this disclosure describes a harvest strategy, a DeFi specific paradigm for VRP harvesting. Table 1 provides an example set of data for implementing the harvest strategy.

TABLE 1
Example

| | |
|---|---|
| Starting balance of the Short-Vol Pool: | Aₜ = 10 BTC |
| Starting balance of the Long-Vol Pool: | Bₜ = 1 BTC |
| Starting value of the underlier: | Pₜ = BTC/USDC 50,000 |
| Ending value of the underlier: | P_{T} = BTC/USDC 51,000 |
| Floating leg: | $f = Min ( \vert \frac{{P}_{T}}{{P}_{t}} - 1 \vert , 1 )$ |
| Fixed leg: | α = 50% |
| Platform fee: | β = 0.1% |
| Observation period: | [t, T] = 23 hours |

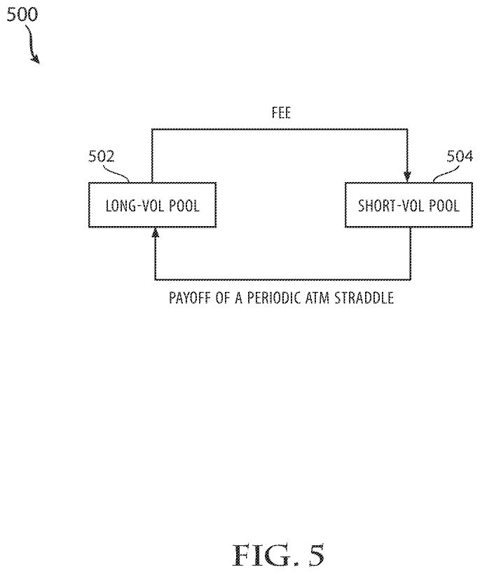

FIG. 5 illustrates a harvesting strategy 500 in accordance with various aspects of this disclosure. Harvesting consists of two capital pools, pool A 302 (as shown in FIG. 3) also known as the short-volatility pool (short-vol pool 502 in FIG. 5), and pool B 304 also known as the long-volatility pool (long-vol pool 504 in FIG. 5). The short-vol pool 502 pays the payoff of a periodic at-the-money (ATM) straddle in exchange for a fixed fee as shown in FIG. 5. For example, if the assumptions in Table 1 apply, in each reset period, the two pools 502, 504 essentially exchange a straddle option trade between each other. The payoff function is the absolute percentage change of USDC/BTC over the 23 hours (or other time frame):

$$f = \frac{51 , 000}{50 , 000} - 1 = 2 \%$$

The floating leg that is paid by the short-vol pool 502 is a straddle with a notional value equal to the size of the short-vol pool 502 at the beginning of the period, that is 10 BTC. The short-vol pool 502 pays 2%×10=0.2 BTC. The fee is 0.1%×10=0.01 BTC. For this straddle, the long-vol pool 504 is paying 50% of its 1 BTC balance at the beginning of the period, i.e. a premium of 0.5 BTC. The long-vol pool 504 pays a premium of 50%×1=0.5 BTC. The fee is 0.1%×1=0.001 BTC. The net payment between the pools is 0.3 BTC from the long-vol pool 504 to the short-vol pool 502. The balances at the end of the period, including the fee charged as a percentage of each pool starting balance, are as follows:

A_{T} =10+0.3−0.01=10.29 BTC

B_{T}=1−0.3−0.001=0.699 BTC

Secondary liquidity is discussed next. As described above, the quantitative strategies will have fixed windows for deposit and withdrawal. Many users will want to add exposure or exit at other times. Since the pool tokens have an intrinsic value determined by the funds in the pool adjusted for the payoff, and since pool tokens are designed to be ERC-20 tokens, it is possible to create a secondary market in these pool tokens. Sellers of pool tokens in the secondary market will be depositors who want to withdraw funds outside of the withdrawal window. Buyers of pool tokens in the secondary market will be users who want to add this specific exposure outside of the deposit window. FIG. 16 illustrates an example separate blockchain-based exchange as one potential secondary market for pool tokens.

There also may be arbitrage players who can participate and build a redeem/create cycle that is common in the electronic funds transfer (ETF) market. The secondary market can trade on any centralized or decentralized exchange as shown in FIG. 16.

Risk transfer is discussed next. Each of the pool tokens also shows that the user has money locked up in a specific volatility structure. Since the parameters of the current payoff for each strategy are known (for example, strikes and the sizes of the pool etc.), and since pool tokens are ERC-20 tokens, pool tokens can be posted to other contracts instead of posting collateral. This allows users to transfer risk between different contracts and thus achieve greater capital/collateral efficiency.

For example, a harvest strategy with daily reset is a straddle where the strike is equal to the price of the underlier at the start of the day. A user (including a product manager) that has deposited some amount into the long-vol pool 504 during the deposit window receives a number of pool tokens.

From a risk management perspective, these pool tokens are just straddles of a specific size (depending on the size of the short-vol pool 502) and strike (where the spot price was at the end of the deposit window).

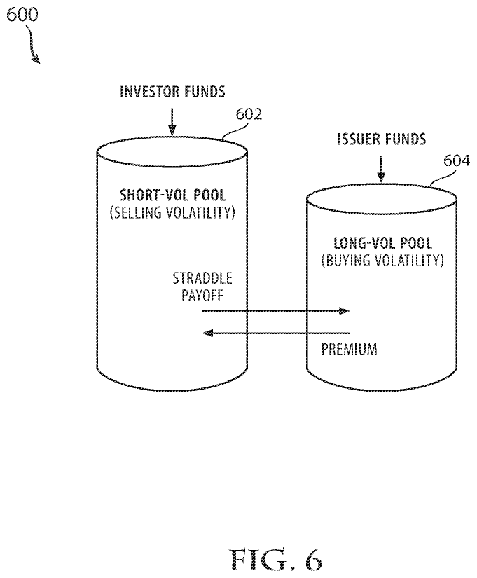

FIG. 6 illustrates the use of a short-volatility pool 602 and a long-volatility pool 604 in accordance with various aspects of this disclosure. The overall system 600 includes both pools. A dual-pool strategy lets investors exchange complex payoffs for a fixed premium to harvest variance risk premium. Investors deposit base currency into short-vol pool 602 and the issuer deposits base currency into the long-vol pool 604. Funds are locked until the next redemption period or timeline. See FIG. 4 for an example timeline. The short-vol pool 602 sells a straddle payoff (ATM BTC/USDC call and put) to the long-vol pool 604, which pays a fixed premium as shown. Both cash flows are proportional in nature, i.e. defined as a fraction of the total value of each pool. Both investors and issuers receive tokens representing their collateral and exposure, with the tokens allowing for secondary liquidity. Every day at a certain time, such as, for example, 8 am Eastern Time (ET), the pools exchange the net payment according to the price of a cryptocurrency such as bitcoin. For a time period, such as from 8-9 am ET, deposits/withdrawals are re-enabled. Anyone holding a token can submit a redemption request, and anyone can deposit new funds into either pool.

Any market participant is free to deposit or withdraw from either pool 602/604 for any given strategy during the designated deposit/redemption window. The deposit/redemption period for each pool serves as an open auction period. The premium/price of any strategy/structured product is determined by the ratio of the two pools 602/604 or the investor pool/issuer pool. The pari-mutuel auction mechanism ensures that the price of any structured product converges to its equilibrium price, while protecting both investors and issuers from negative selection. Both investors and issuers benefit from fair market pricing for the structured products in a cooperative rather than competitive framework. This allows for broader participation without relying on trust in the issuer.

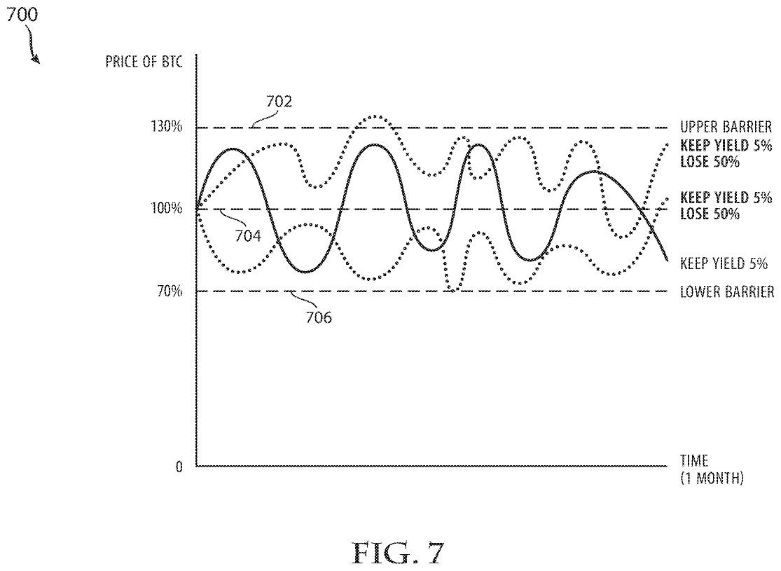

FIG. 7 illustrates a graph 700 of a strategy of providing yields when an underlying asset is expected to be range-bound during a period of time in accordance with various aspects of this disclosure. The strategy is tailored to investors who believe the underlying asset will remain range-bound during an epoch or a period of time. For example, the underlier asset may be bitcoin (BTC) and the epoch or timeframe may be, for example, one month. One can establish barrier levels at say +/−30% with an upper barrier 702 and a lower barrier 706 relative to a keep yield percentage 704. In each time frame such as a one-month epoch, the system observes the BTC price every hour (or other time frame). One pool (the issuer pool) provides a payoff that is a fixed percentage of the pool. Another pool (the investor pool) provides a floating payoff, which is 50% of the pool balance if the price touches initial price +/−barriers 702/706. The relative sizes of the pools will determine the expected yield of the investor. There is a maximum loss for the investor pool in this strategy of 50%.

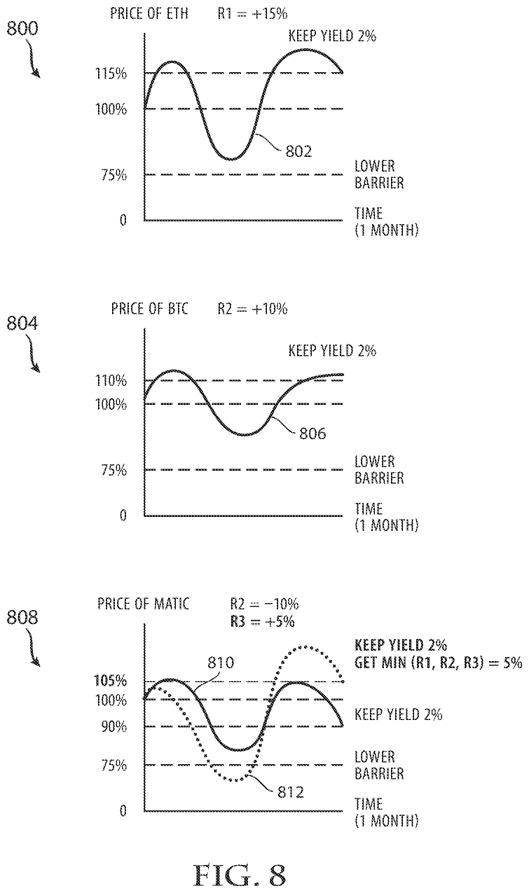

FIG. 8 illustrates three graphs 800, 804, 808 showing three reference assets that will have moderate volatility during a period of time in accordance with various aspects of this disclosure. The underlier assets can be the price of Ethereum (ETH) relative to the US dollar in graph 800, the price of BTC relative to the US dollar in graph 804, or the price of MATIC relative to the US dollar in graph 808. MATIC is a native token on the Polygon blockchain This strategy can be implemented for investors with the opinion that the volatility of the three reference assets will be moderate during an epoch. Suppose for example that the epoch is one month. One pool pays a fixed percentage of the pool balance. Another pool pays a floating percentage of its pool balance which is equal the return of the worst performing reference asset by the end of the epoch (could be negative or positive), but only if the price of any reference asset touches initial price minus 25% (the lower barrier). In each one-month-epoch, the system observes BTC/USD 802, ETH/USD 806, MATIC/USD 810 every hour or other time frame. The data 812 represents an example where the price of MATIC/USD reaches the lower barrier of 75% and the strategy involves returning the “minimum” of the three returns R1, R2, R3, which would be return 3 or R3 at 5%. The R1, R2 and R3 values are the returns of each underlying reference value during the observation period. The smart contract takes the lesser of the three and uses the calculation to determine the floating payoff. The relative sizes of the pools will determine the expected yield of the investor. For example the expected yield could be 24% annually (2% monthly), with a lower barrier is set at −25% (or 75% as shown in the graphs 800, 804, 808). The maximum loss can be 1-for-1 participation of returns for the lowest performing pair of the group of underliers.

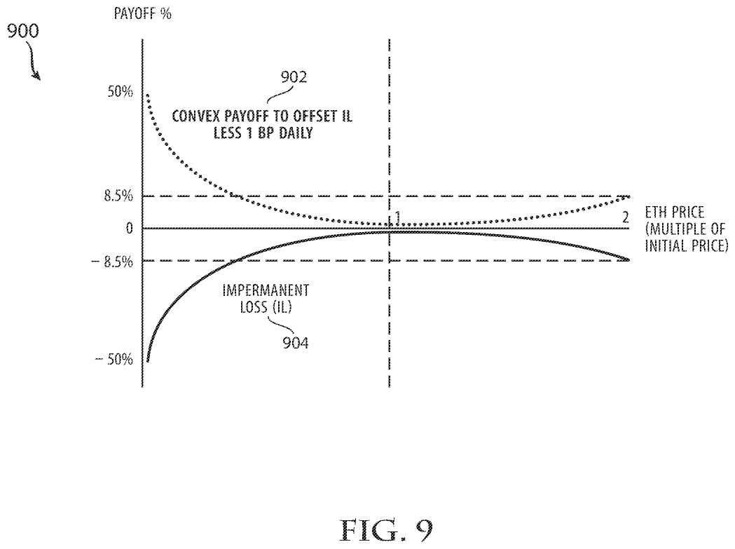

FIG. 9 illustrates a payoff percentage graph 900 for those who want to hedge providing liquidity in accordance with various aspects of this disclosure. This strategy is for investors who want to hedge providing liquidity on Uniswap V2. This is the Uniswap V2 hedge payoff strategy described above. The Uniswap Protocol is an open-source protocol for providing liquidity and trading of ERC-20 tokens on Ethereum. Uniswap is an automated market maker. It can be a collection of smart contracts operating on a blockchain network that defines a standard way to create liquidity pools, provide liquidity and swap assets. Each liquidity pools contains two assets. The pools 302/304 keep track of aggregate liquidity reserves and the pre-defined pricing strategies set by liquidity providers. Reserves and prices are updated automatically every time someone trades. There is no central order book and no third-party custody. There is no private order matching engine. Because reserves are automatically rebalanced after each trade, a Uniswap pool can always be used to buy or sell a token—unlike traditional exchanges, traders do not need to match with individual counterparties to complete a trade.

In one example of FIG. 9, assume an underlying pair of assets is ETH/USD with a one-day epoch. A convex payoff can be:

$$0.5 \times ( \frac{{P}_{t}}{{P}_{0}} + 1 ) - \sqrt{\frac{{P}_{t}}{{P}_{0}}} ,$$

where P₀ , is the price at the beginning of the epoch and Pₜ is the price at the end of the epoch. The strategy can provide a floating payoff such that the user, in each one-day epoch, receives a convex payoff, giving positive convexity 902 to offset negative convexity 904 of providing liquidity on Uniswap V2, or its clones or in another system.

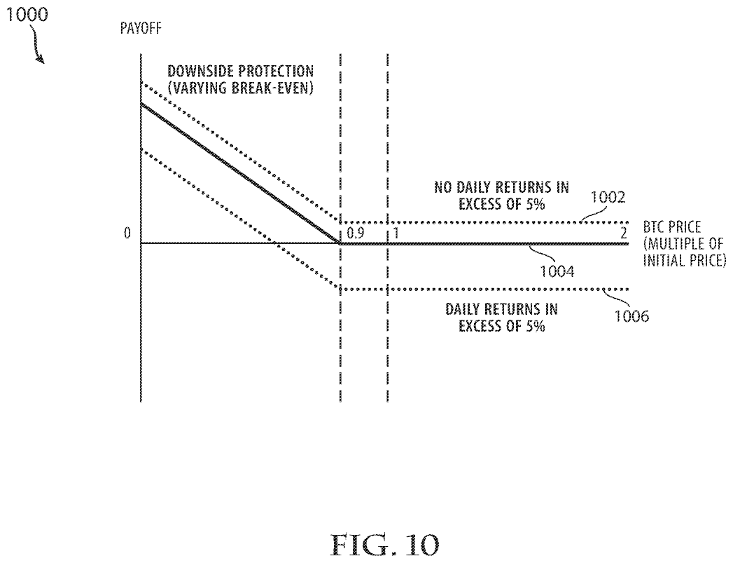

FIG. 10 illustrates a graph 1000 showing an approach to downside protection on a cryptocurrency inventory in accordance with various aspects of this disclosure. The strategy can be for cryptocurrency miners who want downside protection on the cryptocurrency inventory they hold. Assume the asset underlier is BTC/USD and a one-month epoch. The first leg (payoff) is a long 1-month put with a strike of 90%. The second leg (funding) relates to short daily resetting calls with a strike of 105%. The downside protection of a hedged portfolio is 90% protection over the one-month period. The capped upside of the hedged portfolio is no daily returns in excess of 5% 1002. The BTC price 1004 is a multiple of the initial price. In each one-month-epoch, the system observes BTC/USD every day. Leg 1 payoff (hedge leg) involves buying one month put at k=90% of initial spot price. Leg 2 payoff (funding leg) involves selling daily resetting calls at k=105% of spot. The user gets downside protection over the one-month period, in exchange for giving up daily returns in excess of 5%.

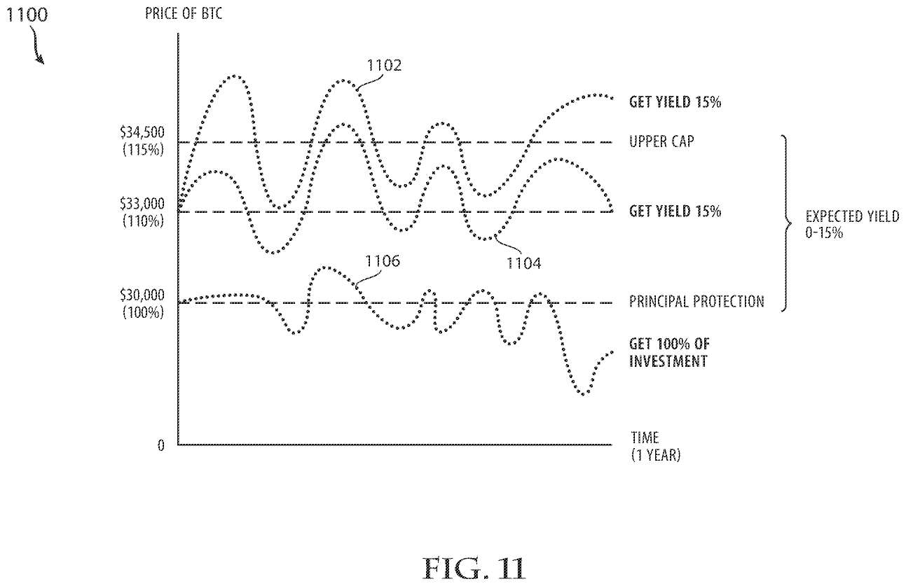

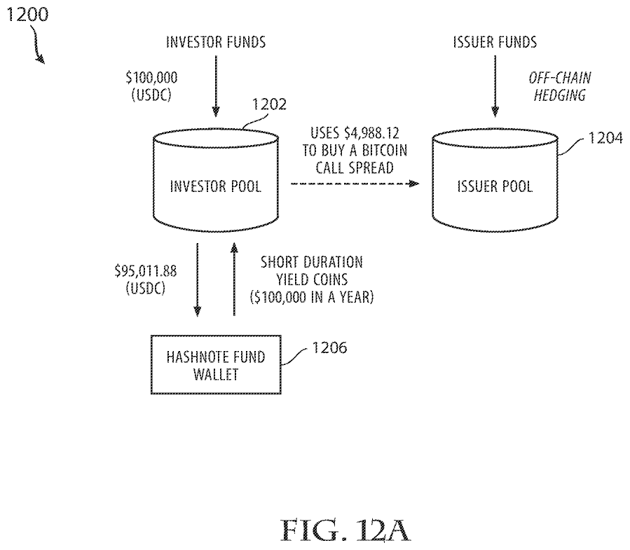

FIG. 11 illustrates a graph 1100 showing use of a principal protection strategy according to some aspects of this disclosure. In this example, assume the underlying asset is BTC/USD and an epoch of 1 year. The strategy uses funds to buy zero coupon treasuries yielding 5.25%. The smart contract uses the interest to buy an option or an option structure. Principal protection occurs because investor gets the principal back, plus profits on optionality. There is a capped upside where the investor gets exposure to BTC upside up to a certain level, such as up to 15% from a starting price.

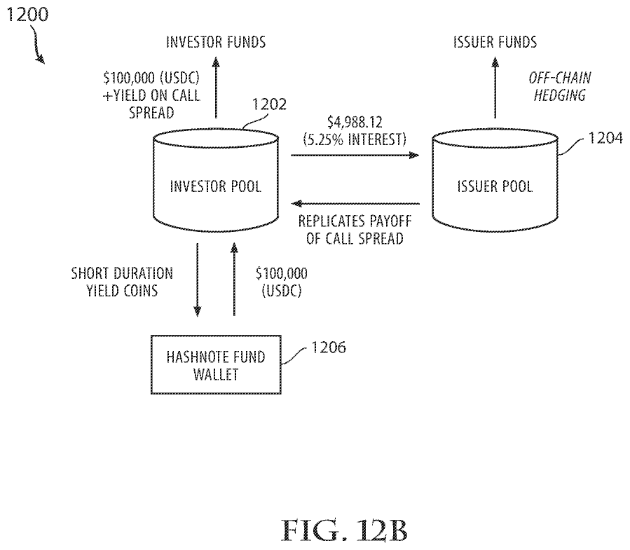

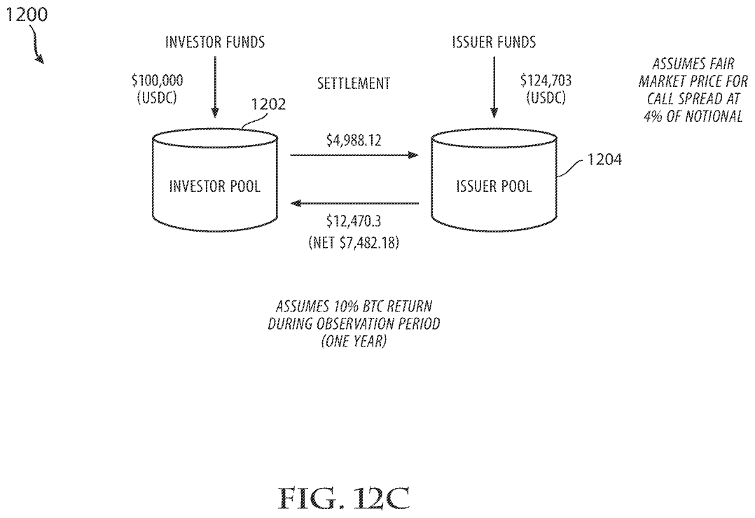

FIGS. 12A-C illustrate an example of the application of the principal protection strategy 1200 in accordance with various aspects of this disclosure. Investors deposit base currency (e.g. $100,000) into an investor pool 1202 and the issuer deposits base currency into the issuer pool 1204. Funds are locked until the next redemption period. Both investors and issuers receive tokens representing their collateral and exposure, with these tokens allowing for secondary liquidity. The investor pool uses $95,011.88 to buy a one-year treasury bill sending funds to a hashnote fund wallet 1206 and receiving hashnote treasury tokens which redeems at $100,000 in one year (yielding 5.25%). The investor pool 1202 uses $4,988.12 to buy a Bitcoin call spread structure from the issuer pool 1204. The issuer pool 1204 sells a call spread payoff struck at 100%/115% of spot ($30,000). Both cash flows are proportional in nature, i.e. defined as a fraction of the total value of each pool.

FIG. 12B illustrates the use of an investor pool 1202 and an issuer pool 1204 in accordance with various aspects of this disclosure. After the period of time such as 1 year, the investor pool 1202 receives the hashnote redemption from the hashnote fund wallet 1206. The hashnote treasury tokens (yielding 5.25%) are redeemed at $100,000. Settlement can also occur after one year. The pools 1202, 1204 exchange the net payment according to the price of BTC. For example, if BTC went up by 10% after one year, the issuer pool 1204 pays 10% of its starting balance. The investor pool 1202 pays a fixed premium (100% of the pool balance after purchasing the hashnote treasury tokens) equal to the 5.25% interest on its $100,000 starting balance ($4,988.12). The investor pool 1202 is charged a platform fee (30 basis points of its $100,000 balance at the beginning of the period). There is a window during which deposits/withdrawals are re-enabled. Anyone holding a token can submit a redemption request, and anyone can deposit new funds into either pool.

FIG. 12C illustrates the use a principal protection strategy 1200 using an investor pool 1202 and an issuer pool 1204 in accordance with various aspects of this disclosure. In this example, assuming a call spread price at 4% of notional ($30,000 spot), the issuer pool 1404 balance would settle at $4,988.12/0.04=$124,703. At settlement after one year (or any other time frame), if BTC went up by 10%, the issuer pool 1404 would pay $12,470.3 to the investor pool 1402 (net payment of $7,482.18). The investor will receive principal ($100,000) plus $7,482.18 less a platform fee of 30 basis points annualized (i.e. $300).

There are some potential extensions and modifications of the principal protected strategy. For example, one could change the participation with lower BTC exposure (e.g. for every $1 of notional the client would get $0.75 of BTC exposure). One strategy could be to add a barrier. For example, the platform could replace the call spread with barrier option. In this case, the option payoff would disappear if some upside barrier is hit (e.g. investor participates in BTC upside up to 50%, but if 150% of the starting price is touched during the life of the structure, buyer only gets back the principal amount at maturity). One strategy could be to reduce the amount of the principal protection—i.e guarantee some large fraction of the initial amount (e.g. 95% instead of 100%), giving us an extra 5% of purchasing power for option buying).

All of these strategies can be implemented by the platform 106/206 such that transactions are controlled by a smart contract and transactions are recorded on the blockchain network as shown in FIG. 16.

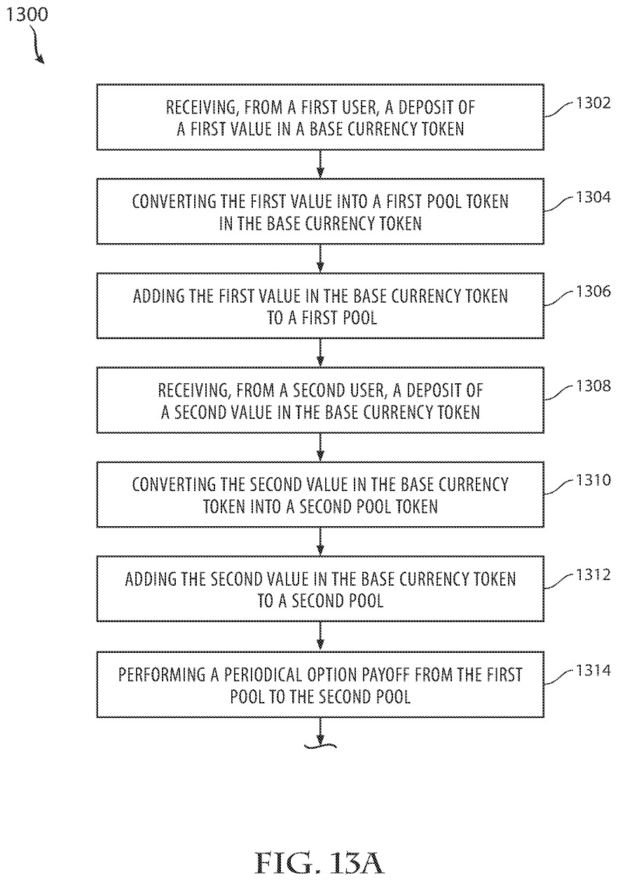

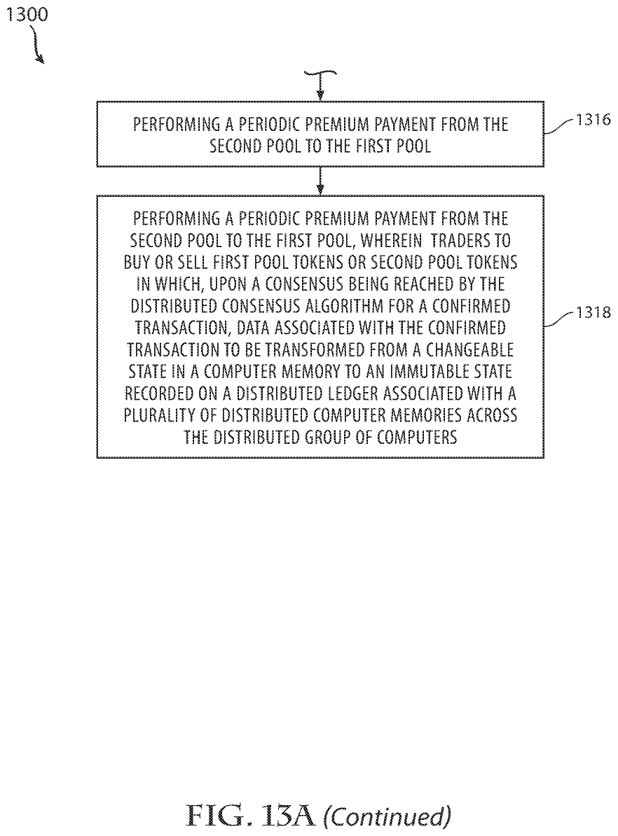

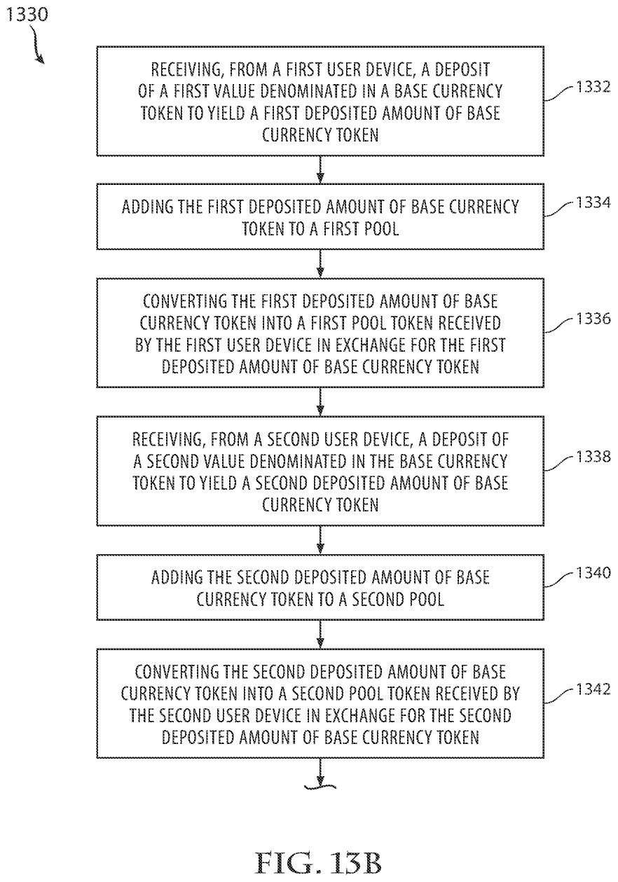

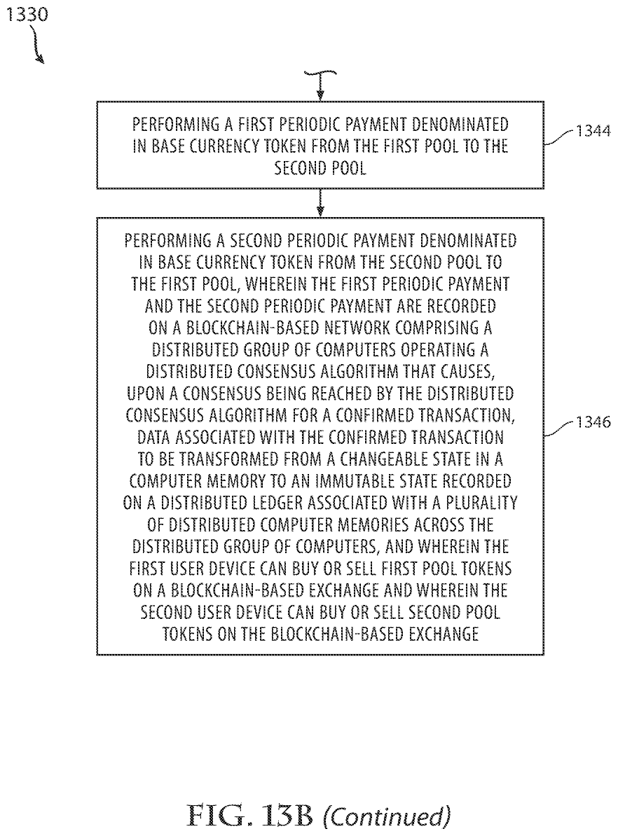

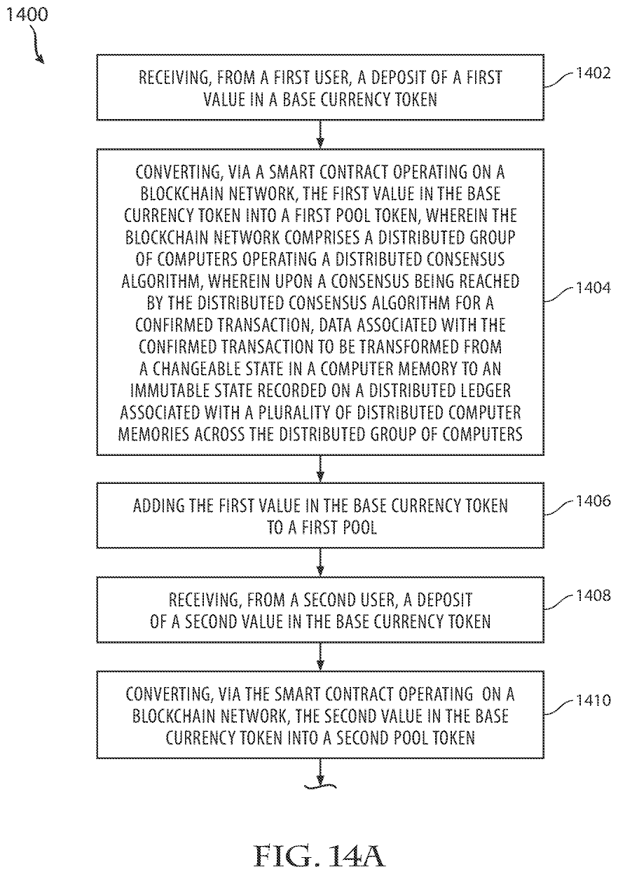

FIG. 13A illustrates an example method in accordance with various aspects of this disclosure. The method 1300 can include one or more steps including receiving, from a first user, a deposit of a first value in a base currency token (1302), converting the first value in the base currency token into a first pool token (1304), adding the first value in the base currency token to a first pool (1306), receiving, from a second user, a deposit of a second value in the base currency token (1308), converting the second value in the base currency token into a second pool token (1310), adding the second value in the base currency token to a second pool (1312), performing a periodical option payoff from the first pool to the second pool (1314), performing a periodic premium payment from the second pool to the first pool (1316) and performing a periodic premium payment from the second pool to the first pool, wherein traders are enabled to buy or sell first pool tokens or second pool tokens in which, upon a consensus being reached by the distributed consensus algorithm for a confirmed transaction, data associated with the confirmed transaction to be transformed from a changeable state in a computer memory to an immutable state recorded on a distributed ledger associated with a plurality of distributed computer memories across the distributed group of computers (1318).

FIG. 13B illustrates a method 1330 of operating an investment system such as the platform 106/206, the method including receiving, from a first user device, a deposit of a first value denominated in a base currency token to yield a first deposited amount of base currency token (1332), adding the first deposited amount of base currency token to a first pool (1334), converting the first deposited amount of base currency token into a first pool token received by the first user device in exchange for the first deposited amount of base currency token (1336), receiving, from a second user device, a deposit of a second value denominated in the base currency token to yield a second deposited amount of base currency token (1338), adding the second deposited amount of base currency token to a second pool (1340) and converting the second deposited amount of base currency token into a second pool token received by the second user device in exchange for the second deposited amount of base currency token (1342).

The method can further include performing a first periodic payment denominated in base currency token from the first pool to the second pool (1344) and performing a second periodic payment denominated in base currency token from the second pool to the first pool, wherein the first periodic payment and the second periodic payment are recorded on a blockchain-based network comprising a distributed group of computers operating a distributed consensus algorithm that causes, upon a consensus being reached by the distributed consensus algorithm for a confirmed transaction, data associated with the confirmed transaction to be transformed from a changeable state in a computer memory to an immutable state recorded on a distributed ledger associated with a plurality of distributed computer memories across the distributed group of computers, and wherein the first user device can buy or sell first pool tokens on a blockchain-based exchange and wherein the second user device can buy or sell second pool tokens on the blockchain-based exchange (1346).

The method 1330 can further include receiving, from the first user device, a withdrawal from the first pool, resulting in a payment of an amount of base currency token from the first pool which depends on a first pool balance to the first user device in exchange for the first pool token and receiving, from the second user device, a withdrawal from the second pool resulting in a payment of an amount of base currency token from the second pool which depends on a second pool balance to the second user device in exchange for the second pool token.

In one aspect, the receiving of deposits or the receiving of withdrawals of value can occur during a fixed window of time. The method can also include periodically adjusting a volatility-based value between the first pool 302 and the second pool 304.

In one aspect performing the first periodic payment from the first pool 302 to the second pool 304 can include a paying the second pool a percentage of a starting balance of the first pool which is linked to a value of a given coin, underlying or observed index.

In another aspect, the step of performing the second periodic payment from the second pool to the first pool can include paying the first pool either a fixed percentage of a starting balance of the second pool, or a percentage which is linked to a value of a given coin, underlying or observed index.

The blockchain-based exchange can be one of a centralized or decentralized exchange which allows for trading of an ERC-20 token or an Ethereum token. Other types of tokens can be used as well as the concepts are not limited to any particular token type.

In one aspect, the first periodic payment and the second periodic payment between the first pool and the second pool can occur according to one of a plurality of risk-management modes (also known as strategies). The following are some examples of risk-management modes. The plurality of risk-management modes can include one or more of a call-write mode, a put-write mode, a harvest mode, a safe harvest mode, a no touch mode, a tail hedge mode, an impermanent loss hedge mode, a ratchet mode, a protected upside mode, a risk reversal mode, a variance mode, and a momentum chaser mode.

The momentum chaser mode can apply where the first pool sells a call when a previous day (or other period of time) was up and sells a put when a previous day (or other period of time) was down, and the second pool has an opposite exposure. The risk reversal mode can include where the first pool pays a payoff of a vanilla put in exchange for a payoff of a vanilla call from the second pool. The call-write mode can include where the first pool pays a payoff of a vanilla call in exchange for a fixed fee from the second pool. The structured investment system of claim 9, wherein the put-write mode can include where the first pool pays a payoff a vanilla put in exchange for a fixed fee from the second pool. The harvest mode can include where the first pool pays a payoff of a periodic at-the-money (ATM) straddle in exchange for a fixed fee from the second pool.

The safe harvest mode can include where the first pool pays a payoff of a periodic at-the-money (ATM) butterfly in exchange for a fixed fee from the second pool. The no touch mode can include where the first pool pays a payoff of a double-no-touch in exchange for a fixed fee from the second pool. The tail hedge mode can include where the first pool pays a payoff of a downside N tail for a fixed fee from the second pool. The impermanent loss hedge mode can include where the first pool pays a payoff of an impermanent loss hedge in exchange for a fixed fee from the second pool, and wherein the payoff comprises a sqrt(R)−0.5*(R+1), where R is the return of the underlying reference value during the observation period. This is the same strategy as the Uniswap V2 hedge payoff strategy described above. The protected upside mode can include where the second pool invests into lending for a period and pledges a yield to buy a payoff of a call option from the first pool. A concept of lending for the period can include buying a token secured by treasuries.

In some aspects, the first user device and the second user device are associated with users or

managers of the structured investment system.

In a system example, a structured investment system can include a processor and a computer-readable storage device storing instructions which, when executed by the processor, cause the processor to perform operations including one or more of: receiving, from a first user device, a deposit of a first value denominated in a base currency token to yield a first amount of deposited base currency token; adding the first amount of deposited base currency token to a first pool; converting the first amount of deposited base currency token into a first pool token received by the first user device in exchange for the first amount of deposited base currency token; receiving, from a second user device, a deposit of a second value denominated in the base currency token to yield a second amount of deposited base currency token; adding the second amount of deposited base currency token to a second pool; and converting the second amount of deposited base currency token into a second pool token received by the second user device in exchange for the second amount of deposited base currency token.

The operations can further include one or more of: performing a first periodic payment denominated in base currency token from the first pool to the second pool; and performing a second periodic payment denominated in the base currency token from the second pool to the first pool. The first periodic payment and the second periodic payment both can be denominated in the base currency token and are recorded on a blockchain-based network. The blockchain-based network can include a distributed group of computers operating a distributed consensus algorithm that causes, upon a consensus being reached by the distributed consensus algorithm for a confirmed transaction, data associated with the confirmed transaction to be transformed from a changeable state in a computer memory to an immutable state recorded on a distributed ledger associated with a plurality of distributed computer memories across the distributed group of computers. The first user device can buy or sell first pool tokens on a blockchain-based exchange and wherein the second user device can buy or sell second pool tokens on a blockchain-based exchange.

In another aspect, the investment system can include a blockchain-based exchange system including a distributed group of computers operating a distributed consensus algorithm that causes confirmed transactions to be recorded on a distributed ledger across the distributed group of computers, at least one processor and a computer-readable storage device storing instructions which, when executed by the at least one processor, cause the at least one processor to perform operations. The operations can include one or more of: receiving, from a first user device, a deposit of a first value denominated in base currency tokens to yield a first amount of base currency tokens; converting the first amount of base currency tokens into a first pool token; adding the first deposit of base currency tokens to a first pool; receiving, from a second user device, a deposit of a second value denominated in base currency tokens to yield a second amount of base currency tokens; converting the second amount of base currency tokens into a second pool token; adding the second amount of base currency tokens to a second pool; performing a first periodic payment from the first pool to the second pool; and performing a second periodic payment from the second pool to the first pool.

In one aspect, deposits of the first value and the second value can only happen at a specific deposit and redemption window. In another aspect, the first value in the first pool and the second value in the second pool is evidenced by the first pool token and the second pool token which can be redeemed from the first pool and second pool in exchange for base currency tokens during the specific deposit and redemption window. Outside of the deposit and redemption window, traders can buy or sell first pool tokens or second pool tokens in which, upon a consensus being reached by a distributed consensus algorithm operating on a blockchain network across a distributed group of computers for a confirmed transaction, data associated with the confirmed transaction is transformed from a changeable state in a computer memory to an immutable state recorded on a distributed ledger associated with a plurality of distributed computer memories across the distributed group of computers.

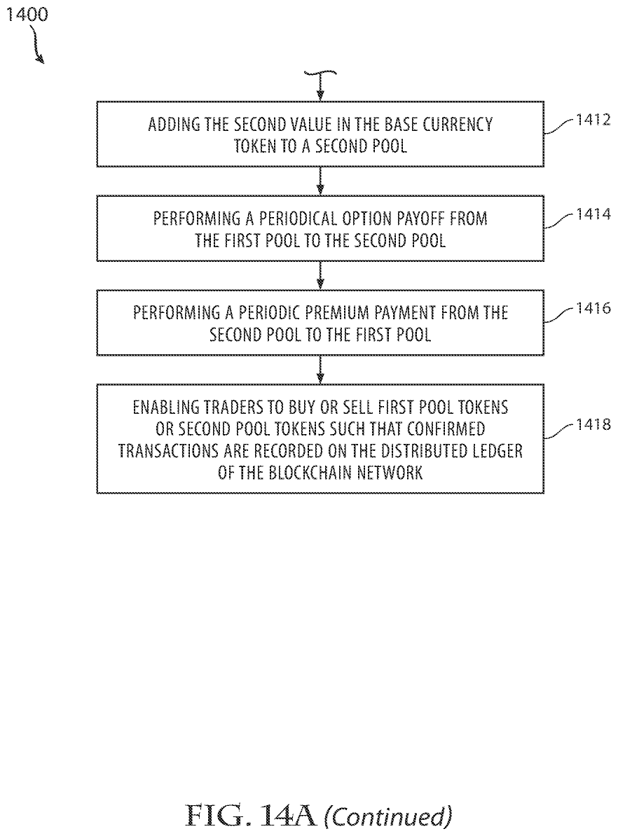

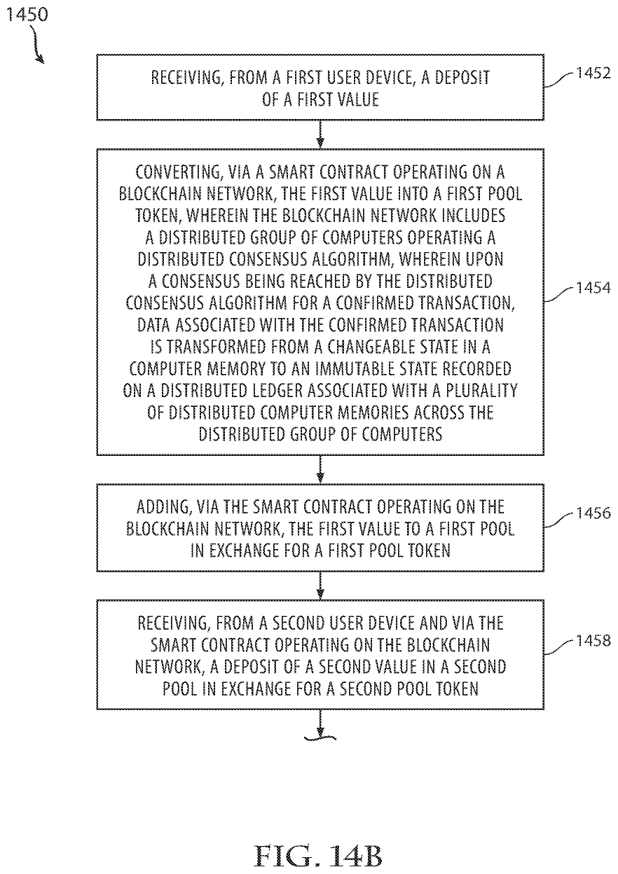

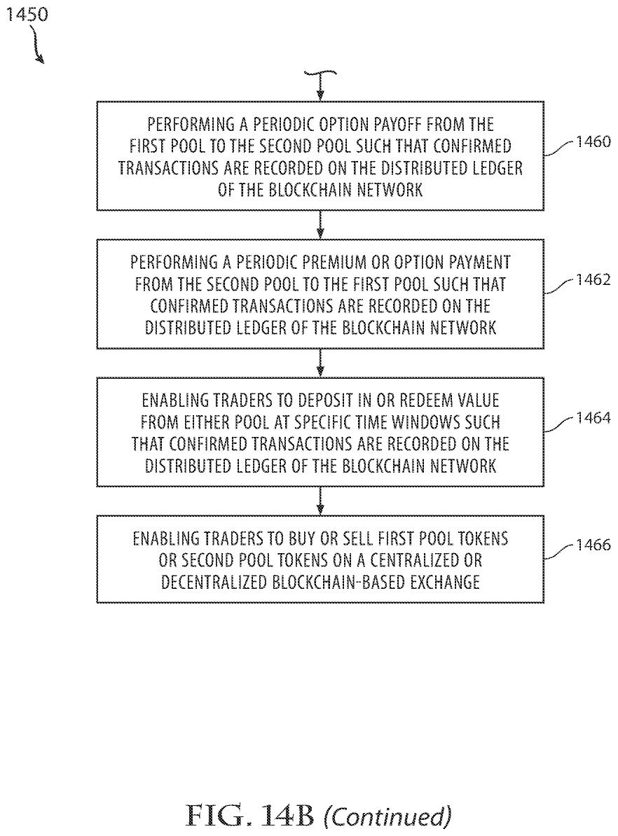

FIG. 14A illustrates a dual-pool structure and a method 1400 of operating such a dual-pool structure. The method 1400 can include one or more of: receiving, from a first user, a deposit of a first value in a base currency token (1402); converting, via a smart contract operating on a blockchain network, the first value in the base currency token into a first pool token, wherein the blockchain network comprises a distributed group of computers operating a distributed consensus algorithm, wherein upon a consensus being reached by the distributed consensus algorithm for a confirmed transaction, data associated with the confirmed transaction to be transformed from a changeable state in a computer memory to an immutable state recorded on a distributed ledger associated with a plurality of distributed computer memories across the distributed group of computers (1404); adding the first value in the base currency token to a first pool (1406); receiving, from a second user, a deposit of a second value in the base currency token (1408); converting, via the smart contract operating on a blockchain network, the second value in the base currency token into a second pool token (1410); adding the second value in the base currency token to a second pool (1412); performing a periodical floating payoff (i.e. based on some reference value, and potentially tied to the volatility of this reference value) from the first pool to the second pool (1414); performing a periodic floating (i.e. based on some reference value, and potentially tied to the volatility of this reference value) or fixed payment from the second pool to the first pool (1416); and enabling traders to buy or sell first pool tokens or second pool tokens such that confirmed transactions are recorded on the distributed ledger of the blockchain network (1418).

The step of enabling traders to buy (from the pool) or sell (to the pool) first pool tokens or second pool tokens can occur within fixed deposit and withdrawal windows.

The method can further include charging, at a beginning of a deposit and withdrawal window, a fee comprising a percentage of a respective pool starting balance at the beginning of the deposit and withdrawal window. The step of performing the periodical payoff from the first pool to the second pool can be proportional such that the periodical payoff is a fraction of a total value of the first pool. The step of performing the periodic payment from the second pool to the first pool is proportional such that the periodic premium payoff can be a fraction of a total value of the second pool.

An example system can include a processor; and a computer-readable storage device storing instructions which, when executed by the processor, cause the processor to perform operations including one or more of: receiving, from a first user device, a deposit of a first value denominated in a base currency token to yield a first amount of deposited base currency token; converting, via a smart contract operating on a blockchain network, the first value into a first pool token, wherein the blockchain network comprises a distributed group of computers operating a distributed consensus algorithm, wherein upon a consensus being reached by the distributed consensus algorithm for a confirmed transaction, data associated with the confirmed transaction is transformed from a changeable state in a computer memory to an immutable state recorded on a distributed ledger associated with a plurality of distributed computer memories across the distributed group of computers; adding the first amount of deposited base currency token to a first pool; receiving, from a second user device, a deposit of a second value denominated in the base currency token to yield a second amount of deposited base currency token; converting, via the smart contract operating on a blockchain network, the second value into a second pool token; adding the second amount of deposited base currency token to a second pool; performing a periodical payment from the first pool to the second pool (which can replicate a volatility-based payoff); performing a periodic payment from the second pool to the first pool (which can replicate the premium paid for a volatility-based payoff); and enabling traders to buy or sell first pool tokens or second pool tokens such that confirmed transactions are recorded on a second blockchain network having a second distributed ledger.

The operation of enabling traders to buy or sell first pool tokens or second pool tokens can occur within fixed deposit and withdrawal windows. The operations can further include charging, at a beginning of a deposit and withdrawal window, a platform fee comprising a percentage of a respective pool starting balance at the beginning of the deposit and withdrawal window. The operation of performing the periodical option payoff from the first pool to the second pool can be proportional such that the periodical option payoff is a fraction of a total value of the first pool and performing the periodic premium payment from the second pool to the first pool is proportional such that the periodic premium payoff is a fraction of a total value of the second pool.

FIG. 14B illustrates another method 1450 of operating a platform. In some aspects, the method 1450 can include: receiving, from a first user device, a deposit of a first value (1452); converting, via a smart contract operating on a blockchain network, the first value into a first pool token, wherein the blockchain network includes a distributed group of computers operating a distributed consensus algorithm, wherein upon a consensus being reached by the distributed consensus algorithm for a confirmed transaction, data associated with the confirmed transaction is transformed from a changeable state in a computer memory to an immutable state recorded on a distributed ledger associated with a plurality of distributed computer memories across the distributed group of computers (1454); adding, via the smart contract operating on the blockchain network, the first value to a first pool in exchange for a first pool token (1456); receiving, from a second user device and via the smart contract operating on the blockchain network, a deposit of a second value in a second pool in exchange for a second pool token (1458); performing a periodic payoff to replicate an option payoff or volatility based payoff from the first pool to the second pool such that confirmed transactions are recorded on the distributed ledger of the blockchain network (1460); performing a periodic payoff to replicate a premium or option payment from the second pool to the first pool such that confirmed transactions are recorded on the distributed ledger of the blockchain network (1462); enabling traders to deposit in or redeem value from either pool at specific time windows such that confirmed transactions are recorded on the distributed ledger of the blockchain network (1464); and enabling traders to buy or sell first pool tokens or second pool tokens on a centralized or decentralized blockchain-based exchange (1466).

In some aspects, the techniques described herein relate to a system including: a processor; and a computer-readable storage device storing instructions which, when executed by the processor, cause the processor to perform operations including: receiving, from a first user device, a deposit of a first value denominated in a base currency token to yield a first amount of deposited base currency token; converting, via a smart contract operating on a first blockchain network, the first value into a first pool token, wherein the first blockchain network includes a distributed group of computers operating a distributed consensus algorithm, wherein upon a consensus being reached by the distributed consensus algorithm for a confirmed transaction, data associated with the confirmed transaction is transformed from a changeable state in a computer memory to an immutable state recorded on a distributed ledger associated with a plurality of distributed computer memories across the distributed group of computers; adding the first amount of deposited base currency token to a first pool; receiving, from a second user device, a deposit of a second value denominated in the base currency token to yield a second amount of deposited base currency token; converting, via the smart contract operating on a blockchain network, the second value into a second pool token; adding the second amount of deposited base currency token to a second pool; performing a periodical floating payoff based on some underlying reference value (which can replicate an option payoff) from the first pool to the second pool; performing a periodic premium payment from the second pool to the first pool, which can be a fixed or floating payoff based on some underlying reference value (which can replicate an option payoff); and enabling traders to buy or sell first pool tokens or second pool tokens such that confirmed transactions are recorded on a second blockchain network having a second distributed ledger.

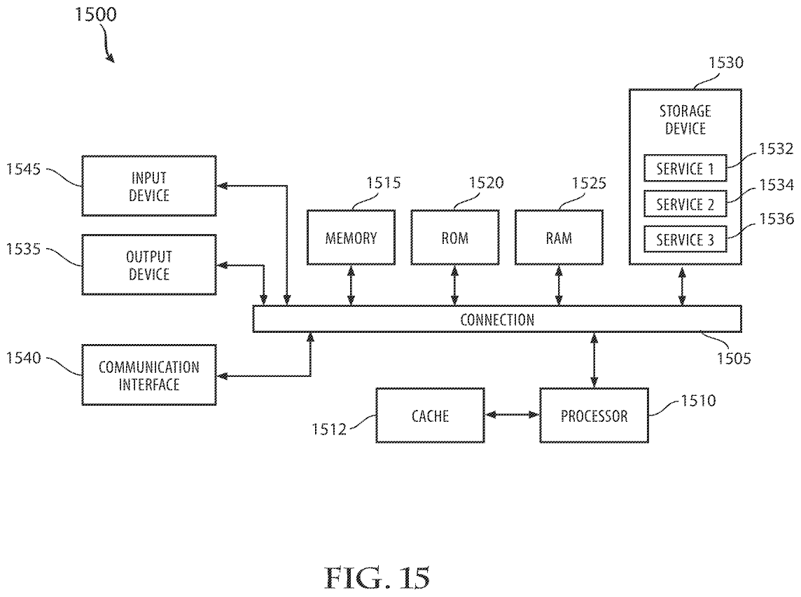

FIG. 15 illustrates the computer hardware components that can be used in computers as part of this disclosure. The system of FIG. 15 can be used as part of a cryptocurrency or blockchain network.

FIG. 15 illustrates an example computing system architecture of a system 1500 which can be used to process data operations and requests, store data content and/or metadata, and perform other computing operations. In this example, the components of the system 1500 are in electrical communication with each other using a connection 1505, such as a bus. The system 1500 includes a processing unit (CPU or processor) 1510 and a connection 1505 that couples various system components including a memory 1515, such as read only memory (ROM) 1520 and random access memory (RAM) 1525, to the processor 1510. The system 1500 can include a cache of high-speed memory connected directly with, in close proximity to, or integrated as part of the processor 1510. The system 1500 can copy data from the memory 1515 and/or the storage device 1530 to cache 1512 for quick access by the processor 1510. In this way, the cache can provide a performance boost that avoids processor 1510 delays while waiting for data. These and other modules can control or be configured to control the processor 1510 to perform various actions. Other memory 1515 may be available for use as well. The memory 1515 can include multiple different types of memory with different performance characteristics. The processor 1510 can include any general purpose processor and a hardware or software service, such as service 1 1532, service 2 1534, and service 3 1536 stored in storage device 1530, configured to control the processor 1510 as well as a special-purpose processor where software instructions are incorporated into the actual processor design. The processor 1510 may be a completely self-contained computing system, containing multiple cores or processors, a bus, memory controller, cache, etc. A multi-core processor may be symmetric or asymmetric.

To enable user interaction with the computing system 1500, an input device 1545 can represent any number of input mechanisms, such as a microphone for speech, a touch-sensitive screen for gesture or graphical input, keyboard, mouse, motion input, speech and so forth. An output device 1535 can also be one or more of a number of output mechanisms known to those of skill in the art. In some instances, multimodal systems can enable a user to provide multiple types of input to communicate with the computing system 1500. The communications interface 1540 can generally govern and manage the user input and system output. There is no restriction on operating on any particular hardware arrangement and therefore the basic features here may easily be substituted for improved hardware or firmware arrangements as they are developed.

Storage device 1530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1525, read only memory (ROM) 1520, and hybrids thereof. The storage device 1530 can include services 1532, 1534, 1536 for controlling the processor 1510. Other hardware or software modules are contemplated. The storage device 1530 can be connected to the connection 1505. In one aspect, a hardware module that performs a particular function can include the software component stored in a computer-readable medium in connection with the necessary hardware components, such as the processor 1510, connection 1505, output device 1535, and so forth, to carry out the function.

For clarity of explanation, in some instances the present technology may be presented as including individual functional blocks including functional blocks including devices, device components, steps or routines in a method embodied in software, or combinations of hardware and software. In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

As noted above, the system disclosed herein may be used in a blockchain network. A blockchain network in one example is a technical infrastructure that provides ledger and smart contract (chaincode) services to applications. Primarily, smart contracts are used to generate transactions which are subsequently distributed to every peer node in the network where they are immutably recorded on their copy of the ledger. In one aspect, a consensus algorithm is distributed across the nodes where the various nodes need to agree on a transaction that is recorded across the distributed ledger. The users of applications might be end users using client applications or blockchain network administrators.

In most cases, multiple organizations come together as a consortium to form the network and their permissions are determined by a set of policies that are agreed by the consortium when the network is originally configured. Importantly, a blockchain network differs from a generic computer in that it includes distributed compute nodes and runs a consensus algorithm across the distributed compute nodes such that the data recorded across the distributed ledger is immutable and cannot be changed. Each node of the plurality of nodes has a copy of the ledger and the consensus algorithm software to participate in processing transactions on the blockchain network. The distributed nature of the hardware, and the software and the processing that occurs renders it impossible to perform the same immutable transactions on a single generic computer.

In one respect the process involves a transformation of the data into a different state or thing. For example, prior to recording, the data associated with a transaction (a cryptocurrency is transferred from a seller to a buyer, which transaction needs to be recorded), is simply data stored in a computer member associated with an exchange. It would be in a state of possibly being altered or deleted via for example a hacker. However, the data once it is recorded on the distributed ledger has changed states. It has become an immutable recording of the data and is thus in a different state than before. This can only be accomplished through using particular machine which is the blockchain network as run by a smart contract to perform the operations disclosed herein. Thus, it is not possible via a simple generic computer which would merely record data of a transaction on in a memory which could be hacked and as a basic matter is not immutable.

Various example systems and methods will be described next which can be understood with reference to the various Appendices as well. An example structured investment system can include a processor and a computer-readable storage device storing instructions which, when executed by the processor, cause the processor to perform operations. The operations can include one or more of the following in any order: receiving, from a first user, a deposit of a first value, converting the first value into a first pool token, adding the first value to a first pool, receiving, from a second user, a deposit of a second value, converting the second value into a second pool token, adding the second value to a second pool, performing a first periodical option payoff from the first pool to the second pool, performing a periodic premium payment from the second pool to the first pool and enabling traders to buy or sell first pool tokens or second pool tokens on a blockchain-based exchange operating a bucket protocol that breaks down option contracts into a series of buckets that function as elementary payout units in which trades are recorded on a blockchain network comprising a distributed group of computers operating a distributed consensus algorithm that causes confirmed transactions to be recorded on a distributed ledger across the distributed group of computers.

The computer-readable storage device stores additional instructions which, when executed by the processor, cause the processor to perform operations comprising one or more of: receiving, from the first user, a withdrawal of the first pool token from the first pool and receiving, from the second user, a withdrawal of the second pool token from the second pool.

The receiving of deposits or the receiving of withdrawals of pool tokens occurs during a fixed window of time. The computer-readable storage device can store additional instructions which, when executed by the processor, cause the processor to perform operations including periodically adjusting a volatility-based value between the first pool of first tokens and the second pool of second tokens.

Performing the first periodical option payoff from the first pool to the second pool can include

a cash flow linked to a value of a given coin, underlying or observed index.

Performing the periodic premium payment from the second pool to the first pool can include paying the first pool a fixed percentage of its starting balance. The blockchain-based exchange can be one of a centralized or decentralized exchange.

The operations described herein can be performed according to one of a plurality of risk-management modes. The plurality of risk-management modes can include one or more of a risk reversal mode, a variance mode, a call-write mode, a put-write mode, a harvest mode, a safe harvest mode, a no touch mode, a tail hedge mode, a impermanent loss hedge mode, a safe harvest mode, a ratchet mode, a protected upside mode and a momentum chaser mode.

The momentum chaser mode can include where the first pool buys a call when a previous day was up and buys a put when a previous day was down, and the second pool has an opposite exposure.

The risk reversal mode can include where an upside pool pays a payoff of a vanilla put in exchange for a payoff of a vanilla call from a downside pool.

The call-write mode can include where a call write pool pays a payoff of a vanilla call in exchange for a fixed fee from a call buy pool. The put-write mode can include where a put write pool pays off a vanilla put in exchange for a fixed fee from a put buy pool.

The harvest mode can include where a short volatility pool pays a payoff of a periodic ATM straddle in exchange for a fixed fee. The safe harvest mode comprises where a short volatility pool pays a payoff of a periodic ATM butterfly in exchange for a fixed fee.

The no touch mode can include where a short volatility pool pays a payoff of a double-no-touch in exchange for a fixed fee. The tail hedge mode can include where a shot volatility pool pays the payoff of a downside N tail for a fixed fee. The impermanent loss hedge mode can include where a shot volatility pool pays a payoff of an impermanent loss hedge in exchange for a fixed fee and wherein the payoff comprises a sqrt(R)−0.5*(R+1), where R is the return of some underlying reference value during the observation period. The protected upside mode can include where a protected pool invests into lending for a period and pledges a yield to a buy call option from an overwrite pool.

Various steps such as the converting steps can be performed by a smart contract operating on a blockchain network. The blockchain network can include a distributed group of computers operating a distributed consensus algorithm that causes confirmed transactions to be recorded on a distributed ledger across the distributed group of computers. This provides an immutable data record of the transaction that cannot be changed. The data regarding the transaction therebefore is converted or transformed from a first state which can be hacked or changed prior to recordation on the ledger to an immutable state where it is recorded on the ledger.

FIG. 16 illustrates an example blockchain network. FIG. 16 illustrates a general blockchain network representing different nodes each communicating with each other, according to some aspects of the present disclosure. The blockchain network 1600 includes a plurality of distributed nodes or computing devices 1602, 1604, 1606, 1608, 1610, 1612, 1614, 1616, 1618. These are devices separated by network such as the Internet. Each of these nodes and computing devices includes a component, module or software as part of a distributed consensus algorithm 1620, 1624, 1628, 1632, 1636, 1640, 1644, 1648, 1652 a part of a distributed consensus algorithm in which transactions that are to be processed by the blockchain network are voted upon by the distributed consensus algorithm. For example, each device can include an instance of the distributed consensus algorithm. The blockchain network 1600 can have various consensus mechanisms, including proof of stake, multisignature, and PBFT (practical Byzantine fault tolerance). Other approaches to consensus are also provided herein.

Another component, module or software provide a distributed ledger 1626, 1630, 1634, 1638, 1642, 1646, 1650, 1654, 1660. An instance or copy of the distributed ledger is in a separate memory at each computing device 1602, 1604, 1606, 1608, 1610, 1612, 1614, 1616, 1618. Again, each node can have an instance or module of the distributed ledger. The general operation of the blockchain is that it will record across the distributed ledger 1626, 1630, 1634, 1638, 1642, 1646, 1650, 1654, 1660 transactions that are voted upon and agreed to by the consensus algorithm 1624, 1628, 1632, 1636, 1640, 1644, 1648, 1652, 1656. The consensus algorithm 1624, 1628, 1632, 1636, 1640, 1644, 1648, 1652, 1656 is also distributed across the computing devices in that an instance or module of the algorithm is operational on each respective computing device of the computing devices 1602, 1604, 1606, 1608, 1610, 1612, 1614, 1616, 1618. A majority of the nodes or whatever threshold needs to be met by the consensus algorithm are needed to record a transaction. The recorded transactions (such as a sale or transfer of a cryptocurrency, or a confirmation of an event or of a validity of a document), are immutable in that the way the distributed ledger works is through adding blocks of data (or a group of transactions) to the ledger in which each block is connected via a hash to data in a previous block. The blockchain network 1600 is a distributed database that maintains a continuously growing list of ordered records, called blocks. The blocks are linked using cryptography. Each block contains a cryptographic hash of the previous block, a timestamp, and transaction data. The blockchain network 1600 is a decentralized, distributed and public or private digital ledger that is used to record transactions across many computers so that the record cannot be altered retroactively without the alteration of all subsequent blocks and the consensus of the network. The data regarding a transaction proceeds through a transition from one state (the pre-ledger state) which could be hacked or shared to another state (a post-ledger state) in which the transaction or data is immutable to the extent that the transaction cannot be altered. These characteristics cannot be obtained via a generic computer storing data in a memory. In such a case, the structure of a generic computer does not enable immutable storage of data on the memory of the computer.

The blockchain network 1600 can be used to record data or transactions related to a number of different use cases. A smart contract 1662 can be configured to operate on one or more computers including in one aspect one or more of the computers in the blockchain network 1600. The smart contract 1662 can be similar to the platform 106/206 discussed above which can operate or perform the functions disclosed herein. The smart contract 1662 can receive data 1666 related to decisions to be made or transactions to be processed. One or more computer memory 1664 can store bits of data 1668. In this example, the bits of data are “101”.

With respect to patent eligibility, whether a claim recites significantly more than an abstract ides or whether a client integrates a judicial exception into a practical application can be determined to be yes when the claim effects a transformation or reduction of a particular article to a different state or thing. In this case, the state of data 1668 stored in a computer memory or memory cell 1660 changes when that data is transitioned from a first computer memory (which can store the data during processing or prior to being recorded on a blockchain network 1600) to a plurality of computer memories across a distributed set of nodes in a blockchain network 1600. Assume that a copy of a blockchain 1602A, 1604A, 1606A, 1608A, 1610A, 1612A, 1614A, 1616A, 1618A is stored respectively in a respective computer memory device at each computing device 1602, 1604, 1606, 1608, 1610, 1612, 1614, 1616, 1618 of the blockchain network 1600. Suppose that the data “101” 1662 needs to be stored in a respective new block 1603, 1605, 1607, 1609, 1611, 1613, 1615, 1617, 1619 of the blockchain Initially, the data “101” 1668 is stored in a memory location not yet on the blockchain 1602A, 1604A, 1606A, 1608A, 1610A, 1612A, 1614A, 1616A, 1618A but is in the processor, RAM or other memory location of a computer. The data is a combination of the logic setting of a memory cell and the physical hardware of the memory cell. In this case, the data “101” 1668 can be deleted or changed. However, once the data “101” 1668 is processed by the distributed consensus algorithm 1624, 1628, 1632, 1636, 1640, 1644, 1648, 1652, 1656 to the satisfaction of the algorithm, the new block 1603, 1605, 1607, 1609, 1611, 1613, 1615, 1617, 1619 in the blockchain 1602A, 1604A, 1606A, 1608A, 1610A, 1612A, 1614A, 1616A, 1618A is created storing this data in an immutable manner across the distributed ledger 1626, 1630, 1634, 1638, 1642, 1646, 1650, 1654, 1660. The process transitions the data 1668 from a standard computer readable memory 1664 to a distributed ledger on a blockchain network 1600 that involves more than merely the manipulation of mathematical constructs. It is a physical change from standard computer readable memory 1664 to new blocks 1603, 1605, 1607, 1609, 1611, 1613, 1615, 1617, 1619 of the blockchain network 1600 stored on respective different computer memories associated with the distributed ledger that makes the data immutable or changes it state from a state of being changeable at a first time based on a set/reset process in a first state to a second state at a second time in which the data is immutable and stored in a plurality of memory locations of the distributed ledger 1626, 1630, 1634, 1638, 1642, 1646, 1650, 1654, 1660 of the blockchain network 1600.

A memory cell 1664 is a fundamental building block of computer memory. The memory cell is an electronic circuit that stores one bit of binary information and it must be set to store a logic 1 (high voltage level) and reset to store a logic 0 (low voltage level). The value in a memory is maintained/stored until it is changed by the set/reset process. The value in the memory cell can be accessed by reading it. The physical object or substance or “article” in this example is a combination of a physical memory cell plus its logic value (0/1) which is determined by the voltage level. The whole point of the blockchain network 1600 is to transform an article (each bit in a computer memory can be considered a separate article) from a changeable state to an immutable state through the process of operating the consensus algorithm and storing the articles (bits) across the distributed ledger and only changeable based on the consensus of the consensus algorithm.

The most common memory cell architecture is MOS memory, which consists of metal-oxide-semiconductor (MOS) memory cells. Modern random-access memory (RAM) uses MOS field-effect transistors (MOSFETs) as flip-flops, along with MOS capacitors for certain types of RAM.

The SRAM (static RAM) memory cell is a type of flip-flop circuit, typically implemented using MOSFETs. These require very low power to keep the stored value when not being accessed. A second type, DRAM (dynamic RAM), is based around MOS capacitors. Charging and discharging a capacitor can store a ‘1’ or a ‘0’ in the cell. However, the charge in this capacitor will slowly leak away, and must be refreshed periodically. Because of this refresh process, DRAM uses more power. DRAM can achieve greater storage densities.

Most non-volatile memory (NVM) is based on floating-gate memory cell architectures. Non-volatile memory technologies including EPROM, EEPROM and flash memory use floating-gate memory cells, which are based around floating-gate MOSFET transistors. Note that no matter what the physical structure is of the memory cell, the process of transforming an article involves transforming the article (a bit or logic value stored in a memory cell) from a first state in which it can be deleted or changes to an immutable state in which the article becomes immutably stored after approval of a distributed consensus algorithm and stored across a distributed ledger in a plurality of new memory cells with the protection of the block structure and the consensus algorithm that prevents changes absent its approval.

A first user device 1670 and a second user device 1672 can provide data to and receive data from the smart contract 1662 to perform the operations or functions disclosed herein. The devices 1670, 1672 can communicate over a network such as the Internet or other network. Note that pool tokens received by the first user device 1670 and the second user device 1672, by way of example, can be exchanged on a separate blockchain-based exchange network 1674. The ability or enabling of the users to sell pool tokens in a secondary market adds a level of flexibility to the strategies disclosed herein. The second or separate blockchain-based exchange network 1674 can have the same characteristics as the blockchain network discussed above with respect to the distributed consensus algorithm, distributed ledger and ability to transform data from a changeable state to an immutable state.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

While the trading network could apply to cryptocurrencies, or securities, it would also be used to trade any other item (digital or physical) of value.

Claim clauses of this disclosure include:

Clause 1. A structured investment system comprising: a processor; and a computer-readable storage device storing instructions which, when executed by the processor, cause the processor to perform operations comprising: receiving, from a first user device, a deposit of a first value denominated in a base currency token to yield a first amount of deposited base currency token; adding the first amount of deposited base currency token to a first pool; converting the first amount of deposited base currency token into a first pool token received by the first user device in exchange for the first amount of deposited base currency token; receiving, from a second user device, a deposit of a second value denominated in the base currency token to yield a second amount of deposited base currency token; adding the second amount of deposited base currency token to a second pool; converting the second amount of deposited base currency token into a second pool token received by the second user device in exchange for the second amount of deposited base currency token; performing a first periodic payment denominated in base currency token from the first pool to the second pool; and performing a second periodic payment denominated in the base currency token from the second pool to the first pool, wherein the first periodic payment and the second periodic payment both denominated in the base currency token are recorded on a blockchain-based network comprising a distributed group of computers operating a distributed consensus algorithm that causes, upon a consensus being reached by the distributed consensus algorithm for a confirmed transaction, data associated with the confirmed transaction to be transformed from a changeable state in a computer memory to an immutable state recorded on a distributed ledger associated with a plurality of distributed computer memories across the distributed group of computers, and wherein the first user device can buy or sell first pool tokens on a blockchain-based exchange and wherein the second user device can buy or sell second pool tokens on the blockchain-based exchange.

Clause 2. The structured investment system of clause 1, wherein the computer-readable storage device stores additional instructions which, when executed by the processor, cause the processor to perform operations comprising one or more of: receiving, from the first user device, a withdrawal from the first pool, resulting in a payment of an amount of base currency token from the first pool which depends on a first pool balance to the first user device in exchange for the first pool token; and receiving, from the second user device, a withdrawal from the second pool resulting in a payment of an amount of base currency token from the second pool which depends on a second pool balance to the second user device in exchange for the second pool token.

Clause 3. The structured investment system of clause 2 or any previous clause, wherein the

receiving of deposits or the receiving of withdrawals of value occurs during a fixed window of time.

Clause 4. The structured investment system of clause 1 or any previous clause, wherein the computer-readable storage device stores additional instructions which, when executed by the processor, cause the processor to perform operations comprising: periodically adjusting a volatility-based value between the first pool and the second pool.

Clause 5. The structured investment system of clause 1 or any previous clause, wherein performing the first periodic payment from the first pool to the second pool comprises a paying the second pool a percentage of a starting balance of the first pool which is linked to a value of a given coin, underlying or observed index.

Clause 6. The structured investment system of clause 1 or any previous clause, wherein performing the second periodic payment from the second pool to the first pool comprises paying the first pool either a fixed percentage of a starting balance of the second pool, or a percentage which is linked to a value of a given coin, underlying or observed index.

Clause 7. The structured investment system of clause 1 or any previous clause, wherein the blockchain-based exchange is one of a centralized or decentralized exchange which allows for trading of an ERC-20 token.

Clause 8. The structured investment system of clause 1 or any previous clause, wherein the first periodic payment and the second periodic payment between the first pool and the second pool occur according to one of a plurality of risk-management modes.

Clause 9. The structured investment system of clause 8 or any previous clause, wherein the

plurality of risk-management modes comprises one or more of a call-write mode, a put-write mode, a harvest mode, a safe harvest mode, a no touch mode, a tail hedge mode, an impermanent loss hedge mode, a ratchet mode, a protected upside mode, a risk reversal mode, a variance mode, and a momentum chaser mode.

Clause 10. The structured investment system of clause 9 or any previous clause, wherein the momentum chaser mode comprises where the first pool sells a call when a previous day was up and sells a put when a previous day was down, and the second pool has an opposite exposure.

Clause 11. The structured investment system of clause 9 or any previous clause, wherein the risk reversal mode comprises where the first pool pays a payoff of a vanilla put in exchange for a payoff of a vanilla call from the second pool.

Clause 12. The structured investment system of clause 9 or any previous clause, wherein the call-write mode comprises where the first pool pays a payoff of a vanilla call in exchange for a fixed fee from the second pool.

Clause 13. The structured investment system of clause 9 or any previous clause, wherein the put-write mode comprises where the first pool pays a payoff a vanilla put in exchange for a fixed fee from the second pool.

Clause 14. The structured investment system of clause 9 or any previous clause, wherein the harvest mode comprises where the first pool pays a payoff of a periodic at-the-money (ATM) straddle in exchange for a fixed fee from the second pool.

Clause 15. The structured investment system of clause 9 or any previous clause, wherein the safe harvest mode comprises where the first pool pays a payoff of a periodic at-the-money (ATM) butterfly in exchange for a fixed fee from the second pool.

Clause 16. The structured investment system of clause 9 or any previous clause, wherein the no touch mode comprises where the first pool pays a payoff of a double-no-touch in exchange for a fixed fee from the second pool.

Clause 17. The structured investment system of clause 9 or any previous clause, wherein the tail hedge mode comprises where the first pool pays a payoff of a downside N tail for a fixed fee from the second pool.

Clause 18. The structured investment system of clause 9 or any previous clause, wherein the impermanent loss hedge mode comprises where the first pool pays a payoff of an impermanent loss hedge in exchange for a fixed fee from the second pool, and wherein the payoff comprises a sqrt(R)−0.5*(R+1) where R is the return of some underlying reference value during some observation period.

Clause 19. The structured investment system of clause 9 or any previous clause, wherein the protected upside mode comprises where the second pool invests into lending for a period and pledges a yield to buy a payoff of a call option from the first pool.

Clause 20. The structured investment system of clause 19 or any previous clause, wherein

lending for the period comprises buying a token secured by treasuries.

Clause 21. The structured investment system of clause 1 or any previous clause, wherein the first user device and the second user device are associated with users or managers of the structured investment system.

Clause 22. A method of operating an investment system, the method comprising: receiving, from a first user device, a deposit of a first value denominated in a base currency token to yield a first deposited amount of base currency token; adding the first deposited amount of base currency token to a first pool; converting the first deposited amount of base currency token into a first pool token received by the first user device in exchange for the first deposited amount of base currency token; receiving, from a second user device, a deposit of a second value denominated in the base currency token to yield a second deposited amount of base currency token; adding the second deposited amount of base currency token to a second pool; converting the second deposited amount of base currency token into a second pool token received by the second user device in exchange for the second deposited amount of base currency token; performing a first periodic payment denominated in base currency token from the first pool to the second pool; and performing a second periodic payment denominated in base currency token from the second pool to the first pool, wherein the first periodic payment and the second periodic payment are recorded on a blockchain-based network comprising a distributed group of computers operating a distributed consensus algorithm that causes, upon a consensus being reached by the distributed consensus algorithm for a confirmed transaction, data associated with the confirmed transaction to be transformed from a changeable state in a computer memory to an immutable state recorded on a distributed ledger associated with a plurality of distributed computer memories across the distributed group of computers, and wherein the first user device can buy or sell first pool tokens on a blockchain-based exchange and wherein the second user device can buy or sell second pool tokens on the blockchain-based exchange.

Clause 23. A structured investment system comprising: a blockchain-based exchange system comprising a distributed group of computers operating a distributed consensus algorithm that causes confirmed transactions to be recorded on a distributed ledger across the distributed group of computers; at least one processor; and a computer-readable storage device storing instructions which, when executed by the at least one processor, cause the at least one processor to perform operations comprising: receiving, from a first user device, a deposit of a first value denominated in base currency tokens to yield a first amount of base currency tokens; converting the first amount of base currency tokens into a first pool token; adding the first deposit of base currency tokens to a first pool; receiving, from a second user device, a deposit of a second value denominated in base currency tokens to yield a second amount of base currency tokens; converting the second amount of base currency tokens into a second pool token; adding the second amount of base currency tokens to a second pool; performing a first periodic payment from the first pool to the second pool; and performing a second periodic payment from the second pool to the first pool, wherein deposits of the first value and the second value can only happen at a specific deposit and redemption window, wherein the first value in the first pool and the second value in the second pool is evidenced by the first pool token and the second pool token which can be redeemed from the first pool and second pool in exchange for base currency tokens during the specific deposit and redemption window, wherein outside of the deposit and redemption window, traders can buy or sell first pool tokens or second pool tokens in which, upon a consensus being reached by a distributed consensus algorithm operating on a blockchain network across a distributed group of computers for a confirmed transaction, data associated with the confirmed transaction is transformed from a changeable state in a computer memory to an immutable state recorded on a distributed ledger associated with a plurality of distributed computer memories across the distributed group of computers.

Clause 24. A method comprising: receiving, from a first user device, a deposit of a first value; converting, via a smart contract operating on a blockchain network, the first value into a first pool token, wherein the blockchain network comprises a distributed group of computers operating a distributed consensus algorithm, wherein upon a consensus being reached by the distributed consensus algorithm for a confirmed transaction, data associated with the confirmed transaction is transformed from a changeable state in a computer memory to an immutable state recorded on a distributed ledger associated with a plurality of distributed computer memories across the distributed group of computers; adding, via the smart contract operating on the blockchain network, the first value to a first pool in exchange for a first pool token; receiving, from a second user device and via the smart contract operating on the blockchain network, a deposit of a second value in a second pool in exchange for a second pool token; performing a periodic floating payoff based on a reference underlying value from the first pool to the second pool such that confirmed transactions are recorded on the distributed ledger of the blockchain network; performing a periodic fixed or floating payment based on a reference underlying value from the second pool to the first pool such that confirmed transactions are recorded on the distributed ledger of the blockchain network; enabling traders to deposit in or redeem value from either pool at specific time windows such that confirmed transactions are recorded on the distributed ledger of the blockchain network; and enabling traders to buy or sell first pool tokens or second pool tokens on a centralized or decentralized blockchain-based exchange.

Clause 25. The method of clause 24, wherein enabling traders to buy or sell first pool tokens from or to the first pool, or buy or sell second pool tokens from or to the first pool occurs within fixed deposit and withdrawal windows.

Clause 26. The method of clause 24 or any previous clause, further comprising: charging, at a beginning of a deposit and withdrawal window, a fee comprising a percentage of a respective pool starting balance at the beginning of the deposit and withdrawal window.

Clause 27. The method of clause 24 or any previous clause, wherein performing the periodic floating payoff from the first pool to the second pool is proportional such that the periodic payoff is a fraction of a total value of the first pool and performing the periodic fixed or floating payoff from the second pool to the first pool is proportional such that the periodic fixed or floating payoff is a fraction of a total value of the second pool.

Clause 28. A system comprising: a processor; and a computer-readable storage device storing instructions which, when executed by the processor, cause the processor to perform operations comprising: receiving, from a first user device, a deposit of a first value denominated in a base currency token to yield a first amount of deposited base currency token; converting, via a smart contract operating on a first blockchain network, the first value into a first pool token, wherein the first blockchain network comprises a distributed group of computers operating a distributed consensus algorithm, wherein upon a consensus being reached by the distributed consensus algorithm for a confirmed transaction, data associated with the confirmed transaction is transformed from a changeable state in a computer memory to an immutable state recorded on a distributed ledger associated with a plurality of distributed computer memories across the distributed group of computers; adding the first amount of deposited base currency token to a first pool; receiving, from a second user device, a deposit of a second value denominated in the base currency token to yield a second amount of deposited base currency token; converting, via the smart contract operating on a blockchain network, the second value into a second pool token; adding the second amount of deposited base currency token to a second pool; performing a periodical floating payoff based on a reference underlying value from the first pool to the second pool; performing a periodic fixed or floating payment based on a reference underlying value from the second pool to the first pool; and enabling traders to buy or sell first pool tokens or second pool tokens such that confirmed transactions are recorded on a second blockchain network having a second distributed ledger.

Clause 29. The system of clause 28, wherein enabling traders to buy or sell first pool tokens or

second pool tokens occurs within fixed deposit and withdrawal windows.

Clause 30. The system of clause 28, wherein the computer-readable storage device stores further instructions which, when executed by the processor, cause the processor to perform operations comprising: charging, at a beginning of a deposit and withdrawal window, a platform fee comprising a percentage of a respective pool starting balance at the beginning of the deposit and withdrawal window.

Clause 31. The system of clause 28 or any previous clause, wherein performing the periodical floating payoff based on a reference underlying value from the first pool to the second pool is proportional such that the periodical option payoff is a fraction of a total value of the first pool and performing the periodic premium payment from the second pool to the first pool is proportional such that the periodic premium payoff is a fraction of a total value of the second pool.

Clause 32. A method of operating a structured trading platform, the method comprising: receiving in a pool, funding tokens from a user; at an end of a periodic period of time, via a smart contract, implementing a predefined option trading strategy associated with one of a long volatility trading strategy or a short volatility trading strategy; and buying or selling, via the platform, volatility exposure using tokens in the pool according to the predefined option trading strategy, such that confirmed transactions are recoded on a blockchain network that comprises a distributed group of computers operating a distributed consensus algorithm, wherein upon a consensus being reached by the distributed consensus algorithm for a confirmed transaction of the confirmed transactions, data associated with the confirmed transaction is transformed from a changeable state in a computer memory to an immutable state recorded on a distributed ledger associated with a plurality of distributed computer memories across the distributed group of computers.

Clause 33. The method of clause 32, wherein the receiving in the pool of the funding tokens

from the user occurs during a fixed deposit/withdrawal window.

Clause 34. The method of clause 32 or any previous clause, wherein buying or selling, via the

smart contract, the volatility exposure comprises buying calls and puts or selling calls and puts.

Clause 35. The method of clause 32 or any previous clause, wherein the structured trading platform comprises a first pool having a short volatility strategy and a second pool comprising a long-volatility strategy.

Clause 36. The method of clause 32 or any previous clause, wherein the periodic period of time comprises a beginning of an observation period, an observation period, a settlement period and a rebalancing period.

Clause 37. The method of clause 36 or any previous clause, wherein at an end of the rebalancing

period, the platform processes deposits and redemptions and resets the periodic period of time.

Clause 38. A system comprising: a processor; and a computer-readable storage device storing instructions which, when executed by the processor, cause the processor to perform operations comprising: receiving in a pool, funding tokens from a user; at an end of a periodic period of time, via a smart contract, implementing a predefined option trading strategy associated with one of a long volatility trading strategy or a short volatility trading strategy; and buying or selling, via the smart contract, volatility exposure using tokens in the pool according to the predefined option trading strategy, such that confirmed transactions are recoded on a blockchain network that comprises a distributed group of computers operating a distributed consensus algorithm, wherein upon a consensus being reached by the distributed consensus algorithm for a confirmed transaction of the confirmed transactions, data associated with the confirmed transaction is transformed from a changeable state in a computer memory to an immutable state recorded on a distributed ledger associated with a plurality of distributed computer memories across the distributed group of computers.

Clause 39. The system of clause 38, wherein the receiving in the quantitative pool of the funding

tokens from the user occurs during a fixed deposit/withdrawal window.

Clause 40. The system of clause 38 or any previous clause, wherein buying or selling, via the

platform, the volatility exposure comprises buying calls and puts or selling calls and puts.

Clause 41. The system of clause 38 or any previous clause, wherein the quantitative pool comprises a first pool having a short volatility strategy and a second pool comprising a long-volatility strategy.

Clause 42. The system of clause 38 or any previous clause, wherein the periodic period of time comprises a beginning of an observation period, an observation period, a settlement period and a rebalancing period.

Clause 43. The system of clause 42 or any previous clause, wherein at an end of the rebalancing

period, the platform processes deposits and redemptions and resets the periodic period of time.

Clause 44. A system including one or more means for performing any function, step or

operation of any previous clause.

Clause 45. A non-transitory computer-readable device that stores instructions which, when executed by a processor, cause the processor to perform one or more functions, steps or operations of any previous clause.

We claim:

1. A structured investment system comprising:
a processor; and
a computer-readable storage device storing instructions which, when executed by the processor, cause the processor to perform operations comprising:
receiving, from a first user device, a deposit of a first value denominated in a base currency token to yield a first amount of deposited base currency token;
adding the first amount of deposited base currency token to a first pool;
converting the first amount of deposited base currency token into a first pool token received by the first user device in exchange for the first amount of deposited base currency token;
receiving, from a second user device, a deposit of a second value denominated in the base currency token to yield a second amount of deposited base currency token;
adding the second amount of deposited base currency token to a second pool;
converting the second amount of deposited base currency token into a second pool token received by the second user device in exchange for the second amount of deposited base currency token;
performing a first periodic payment denominated in base currency token from the first pool to the second pool; and
performing a second periodic payment denominated in the base currency token from the second pool to the first pool,
wherein the first periodic payment and the second periodic payment both denominated in the base currency token are recorded on a blockchain-based network comprising a distributed group of computers operating a distributed consensus algorithm that causes, upon a consensus being reached by the distributed consensus algorithm for a confirmed transaction, data associated with the confirmed transaction to be transformed from a changeable state in a computer memory to an immutable state recorded on a distributed ledger associated with a plurality of distributed computer memories across the distributed group of computers, and wherein the first user device can buy or sell first pool tokens on a blockchain-based exchange and wherein the second user device can buy or sell second pool tokens on the blockchain-based exchange.

2. The structured investment system of claim 1, wherein the computer-readable storage device stores additional instructions which, when executed by the processor, cause the processor to perform operations comprising one or more of:
receiving, from the first user device, a withdrawal from the first pool, resulting in a payment of an amount of base currency token from the first pool which depends on a first pool balance to the first user device in exchange for the first pool token; and
receiving, from the second user device, a withdrawal from the second pool resulting in a payment of an amount of base currency token from the second pool which depends on a second pool balance to the second user device in exchange for the second pool token.

3. The structured investment system of claim 2, wherein the receiving of deposits or the receiving of withdrawals of value occurs during a fixed window of time.

4. The structured investment system of claim 1, wherein the computer-readable storage device stores additional instructions which, when executed by the processor, cause the processor to perform operations comprising:
periodically adjusting a volatility-based value between the first pool and the second pool.

5. The structured investment system of claim 1, wherein performing the first periodic payment from the first pool to the second pool comprises a paying the second pool a percentage of a starting balance of the first pool which is linked to a value of a given coin, underlying or observed index.

6. The structured investment system of claim 1, wherein performing the second periodic payment from the second pool to the first pool comprises paying the first pool either a fixed percentage of a starting balance of the second pool, or a percentage which is linked to a value of a given coin, underlying or observed index.

7. The structured investment system of claim 1, wherein the blockchain-based exchange is one of a centralized or decentralized exchange which allows for trading of an ERC-20 token.

8. The structured investment system of claim 1, wherein the first periodic payment and the second periodic payment between the first pool and the second pool occur according to one of a plurality of risk-management modes.

9. The structured investment system of claim 8, wherein the plurality of risk-management modes comprises one or more of a call-write mode, a put-write mode, a harvest mode, a safe harvest mode, a no touch mode, a tail hedge mode, an impermanent loss hedge mode, a ratchet mode, a protected upside mode, a risk reversal mode, a variance mode, and a momentum chaser mode.

10. The structured investment system of claim 9, wherein the momentum chaser mode comprises where the first pool sells a call when a previous day was up and sells a put when a previous day was down, and the second pool has an opposite exposure.

11. The structured investment system of claim 9, wherein the risk reversal mode comprises where the first pool pays a payoff of a vanilla put in exchange for a payoff of a vanilla call from the second pool.

12. The structured investment system of claim 9, wherein the call-write mode comprises where the first pool pays a payoff of a vanilla call in exchange for a fixed fee from the second pool.

13. The structured investment system of claim 9, wherein the put-write mode comprises where the first pool pays a payoff a vanilla put in exchange for a fixed fee from the second pool.

14. The structured investment system of claim 9, wherein the harvest mode comprises where the first pool pays a payoff of a periodic at-the-money (ATM) straddle in exchange for a fixed fee from the second pool.

15. The structured investment system of claim 9, wherein the safe harvest mode comprises where the first pool pays a payoff of a periodic at-the-money (ATM) butterfly in exchange for a fixed fee from the second pool.

16. The structured investment system of claim 9, wherein the no touch mode comprises where the first pool pays a payoff of a double-no-touch in exchange for a fixed fee from the second pool.

17. The structured investment system of claim 9, wherein the tail hedge mode comprises where the first pool pays a payoff of a downside N tail for a fixed fee from the second pool.

18. The structured investment system of claim 9, wherein the impermanent loss hedge mode comprises where the first pool pays a payoff of an impermanent loss hedge in exchange for a fixed fee from the second pool, and wherein the payoff comprises a sqrt(R)−0.5*(R+1) where R is the return of some underlying reference value during the observation period.

19. The structured investment system of claim 9, wherein the protected upside mode comprises where the second pool invests into lending for a period and pledges a yield to buy a payoff of a call option from the first pool, wherein lending for the period comprises buying a token secured by treasuries and wherein the first user device and the second user device are associated with users or managers of the structured investment system.

20. A method of operating an investment system, the method comprising:
receiving, from a first user device, a deposit of a first value denominated in a base currency token to yield a first deposited amount of base currency token;
adding the first deposited amount of base currency token to a first pool;
converting the first deposited amount of base currency token into a first pool token received by the first user device in exchange for the first deposited amount of base currency token;
receiving, from a second user device, a deposit of a second value denominated in the base currency token to yield a second deposited amount of base currency token;
adding the second deposited amount of base currency token to a second pool;
converting the second deposited amount of base currency token into a second pool token received by the second user device in exchange for the second deposited amount of base currency token;
performing a first periodic payment denominated in base currency token from the first pool to the second pool; and
performing a second periodic payment denominated in base currency token from the second pool to the first pool, wherein the first periodic payment and the second periodic payment are recorded on a blockchain-based network comprising a distributed group of computers operating a distributed consensus algorithm that causes, upon a consensus being reached by the distributed consensus algorithm for a confirmed transaction, data associated with the confirmed transaction to be transformed from a changeable state in a computer memory to an immutable state recorded on a distributed ledger associated with a plurality of distributed computer memories across the distributed group of computers, and wherein the first user device can buy or sell first pool tokens on a blockchain-based exchange and wherein the second user device can buy or sell second pool tokens on the blockchain-based exchange.
